(19) United States
(12) Patent Application Publication
(10) Pub. No.: US 2025/0121291 A1
(43) Pub. Date: Apr. 17, 2025

(54) PROGRAM, INFORMATION PROCESSING SYSTEM, AND INFORMATION PROCESSING METHOD

(71) Applicant: CYGAMES, INC., Tokyo (JP)

(72) Inventors: Hironori Sato, Tokyo (JP); Yusuke Hayashi, Tokyo (JP); Masaru Kubo, Tokyo (JP); Mitsunori Tanaka, Tokyo (JP); Tomohiro Hasegawa, Tokyo (JP); Nozomi Kikuchi, Tokyo (JP); Reiji Suzumaru, Tokyo (JP); Yuka Tanaka, Tokyo (JP)

(73) Assignee: CYGAMES, INC., Tokyo (JP)

(21) Appl. No.: 18/980,991

(22) Filed: Dec. 13, 2024

Related U.S. Application Data
(63) Continuation of application No. PCT/JP2023/019094, filed on May 23, 2023.

(30) Foreign Application Priority Data
Jun. 28, 2022 (JP) 2022-103649

(51) Int. Cl. A63F 13/69; A63F 13/79; A63F 13/828; A63F 13/85

(52) U.S. Cl. CPC A63F 13/69; A63F 13/79; A63F 13/828; A63F 13/85

(57) ABSTRACT

Provided is a program, an information processing system, and an information processing method that enhance the game interest of a player. Characters to be used by a player can be selected from a plurality of types of characters and the characters that have satisfied a registration condition are registered in an illustrated reference book. The presence/absence of a registration status in the illustrated reference book is managed in association with the types of characters, and advantageous effects for the progression of the game are set in accordance with the types of characters registered in the illustrated reference book. The advantageous effects set in accordance with the types of characters selected as the registration targets of the illustrated reference book are applied to the game progression regardless of the types of characters selected as the use targets.

### CROSS-REFERENCE TO RELATED APPLICATIONS

This application is a continuation of International Patent Application No. PCT/JP2023/019094, having an international filing date of May 23, 2023, which designated the United States, the entirety of which is incorporated herein by reference. Japanese Patent Application No. 2022-103649 filed on Jun. 28, 2022 is also incorporated herein by reference in its entirety.

### BACKGROUND OF THE INVENTION

The present invention relates to a program, an information processing system, and an information processing method for a game in which a plurality of types of characters appear.

In the related art, there is a known game including an illustrated-reference-book function for registering characters, items, etc. that appear in a game in an illustrated reference book and allowing possession upper limits of the characters, the items, etc. to be increased in accordance with the registration statuses of the characters, the items, etc. in the illustrated reference book (see “(Puyopuyo!! Quest) About the illustrated-reference-book level and the illustrated-reference-book bonus” [online], 22 Mar. 2021, Game 8, Puyopuyo!! Quest walkthrough Wiki, [Retrieval date 24 May 2022], Internet <URL: https://game8.jp/puyoque/156612>).

Here, because the illustrated-reference-book function has the effect of increasing the possession upper limits of the characters, the items, etc. in accordance with the registered numbers thereof in the illustrated reference book, said function is mainly utilized just to satisfy the collecting desire of a player.

### SUMMARY OF THE INVENTION

The present invention has been conceived in light of the above-described circumstances, and an object thereof is to provide a program, an information processing system, and an information processing method for enhancing the game interest of a player.

According to a first aspect of the disclosure, there is provided a program for a game in which a plurality of types of characters appear,
the program causing a computer to function as an illustrated-reference-book-function provision portion that registers the characters that have satisfied a registration condition in an illustrated reference book, wherein
the illustrated-reference-book-function provision portion
manages the presence/absence of a registration status in the illustrated reference book in association with the types of characters and sets advantageous effects for the progression of the game in accordance with the types of characters registered in the illustrated reference book.

According to a second aspect of the disclosure, there is provided an information processing system for a game in which a plurality of types of characters appear,
the system comprising an illustrated-reference-book-function provision portion that registers the characters that have satisfied a registration condition in an illustrated reference book, wherein
the illustrated-reference-book-function provision portion
manages the presence/absence of a registration status in the illustrated reference book in association with the types of characters and sets advantageous effects for the progression of the game in accordance with the types of characters registered in the illustrated reference book.

According to a third aspect of the disclosure, there is provided an information processing method for a game in which a plurality of types of characters appear, the method comprising:
an illustrated-reference-book registering step of registering the characters that have satisfied a registration condition in an illustrated reference book and managing the presence/absence of a registration status in the illustrated reference book in association with the types of characters; and
an effect setting step of setting advantageous effects for the progression of the game in accordance with the types of characters registered in the illustrated reference book.

### BRIEF DESCRIPTION OF DRAWINGS

FIG. 1 is a diagram showing the overall configuration of an information processing system.

FIG. 2 is a functional block diagram showing functions related to a server among functions realized by means of the information processing system.

FIG. 3 is a functional block diagram showing functions related to a player terminal among the functions realized by means of the information processing system.

FIG. 4 is a flowchart showing an example of processing related to an event function.

FIG. 5 is a diagram showing an example of an event top screen displayed in the player terminal.

FIG. 6 is a diagram showing an example of a race-schedule confirmation dialog displayed in the player terminal.

FIG. 7 is a diagram showing an example of a competition-opponent selection screen displayed in the player terminal.

FIG. 8 is a diagram showing an example of an entry confirmation screen displayed in the player terminal.

FIG. 9 is a diagram showing an example of the entry confirmation screen displayed in the player terminal.

FIG. 10 is a diagram showing an example of an aptitude confirmation dialog displayed in the player terminal.

FIG. 11 is a diagram showing an example of a competition result screen displayed in the player terminal.

FIG. 12 is a diagram showing an example of a reward acquisition screen displayed in the player terminal.

FIG. 13 is a diagram showing an example of an illustrated-reference-book update notification dialog displayed in the player terminal.

FIG. 14 is a diagram showing an example of a team-evaluation update dialog displayed in the player terminal.

FIG. 15 is a diagram showing an example of a recruitment accepting screen displayed in the player terminal.

FIG. 16 is a diagram showing an example of a recruitment-target selection screen displayed in the player terminal.

FIG. 17 is a diagram showing an example of a replacement-target selection screen displayed in the player terminal.

FIG. 18 is a diagram showing an example of the recruitment accepting screen displayed in the player terminal.

FIG. 19 is a flowchart showing an example of the processing related to the event function.

FIG. 20 is a diagram showing an example of a team confirmation screen displayed in the player terminal.

FIG. 21 is a diagram showing an example of a captain selection screen displayed in the player terminal.

FIG. 22 is a diagram showing an example of a team strategy dialog displayed in the player terminal.

FIG. 23 is a diagram showing an example of an illustrated-reference-book viewing screen displayed in the player terminal.

FIG. 24 is a diagram showing an example of the illustrated-reference-book viewing screen displayed in the player terminal.

### DETAILED DESCRIPTION OF THE INVENTION

(1) The present embodiment relates to a program for a game in which a plurality of types of characters appear, the program causing a computer to function as an illustrated-reference-book-function provision portion that registers the characters that have satisfied a registration condition in an illustrated reference book, wherein the illustrated-reference-book-function provision portion manages the presence/absence of a registration status in the illustrated reference book in association with the types of characters and sets advantageous effects for the progression of the game in accordance with the types of characters registered in the illustrated reference book.

(2) With the program of the present embodiment, the illustrated-reference-book-function provision portion may enable the registration of the characters in the illustrated reference book in an event held for a period set in advance and the advantageous effects may be set in correspondence with the period in which said event is held.

(3) The program of the present embodiment may be configured so that: the characters to be used by a player can be selected from the plurality of types of characters; and the advantageous effects set in accordance with the types of characters selected as the registration targets for the illustrated reference book are applied to the game progression regardless of the types of characters selected as the use targets.

(4) The program of the present embodiment may be configured so that: a team can be organized by the player selecting the characters from the plurality of types of characters; and the illustrated-reference-book-function provision portion registers the characters in the illustrated reference book on the basis of organization information of the team.

(5) The present embodiment relates to an information processing system for a game in which a plurality of types of characters appear, the system comprising an illustrated-reference-book-function provision portion that registers the characters that have satisfied a registration condition in an illustrated reference book, wherein the illustrated-reference-book-function provision portion manages the presence/absence of a registration status in the illustrated reference book in association with the types of characters and sets advantageous effects for the progression of the game in accordance with the types of characters registered in the illustrated reference book.

(6) The present embodiment relates to an information processing method for a game in which a plurality of types of characters appear, the method comprising: an illustrated-reference-book registering step of registering the characters that have satisfied a registration condition in an illustrated reference book and managing the presence/absence of a registration status in the illustrated reference book in association with the types of characters; and an effect setting step of setting advantageous effects for the progression of the game in accordance with the types of characters registered in the illustrated reference book.

Configuring the program, the information processing system, and the information processing method of the present embodiment so that effects that are advantageous for the game progression are set in accordance with the types of characters registered in the illustrated reference book acts as a motivation for playing the game in order to satisfy the registration conditions of the illustrated reference book for various characters, and thus, it is possible to enhance the game interest of a player.

In the following, an embodiment of the present invention will be described. Note that this embodiment that will be described below does not unfairly limit the scope of the invention set forth in the claims. In addition, the configurations that will be described in this embodiment are not necessarily entirely indispensable constituent features of the present invention.

### 1. Configuration of Information Processing System

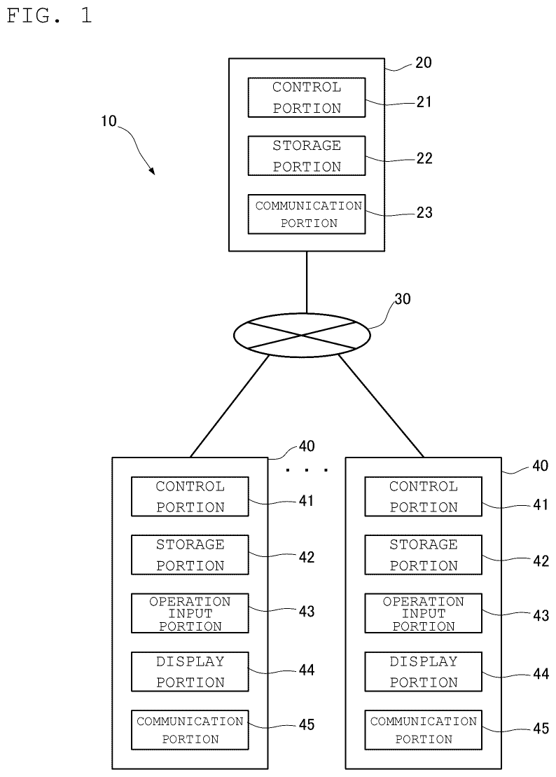

FIG. 1 is a diagram showing the overall configuration of an information processing system 10 of this embodiment. As shown in FIG. 1, in the information processing system 10, a server 20 and a plurality of player terminals 40 are connected by a network 30, such as the Internet, a mobile phone network, an LAN, a WAN, and thus, a so-called client-server communication system is constructed. Also, each of the plurality of player terminals 40 mutually communicates with the server 20 via the network 30 to transmit and receive various kinds of information. In addition, each of the plurality of player terminals 40 mutually communicate with the other player terminals 40 via the network 30 and the server 20 to transmit and receive various kinds of information.

The server 20 includes: a control portion 21 consisting of a processor, such as a CPU; a storage portion 22 consisting of a main storage device, such as a ROM or a RAM, and an auxiliary storage device, such as an HDD or an SSD; and a communication portion 23 consisting of a communication module or a communication interface. In the server 20, the control portion 21 executes various kinds of processing in accordance with programs stored in the storage portion 22. In addition, the server 20 receives information from the player terminals 40 by means of the communication portion 23 and transmits information related to results of the processing executed by the control portion 21, etc. to the player terminals 40.

The player terminals 40 are smartphones, tablets, personal computers, portable game machines, stationary game machines installed at stores and homes, etc. Each of the player terminals 40 includes: a control portion 41 consisting of a processor, such as a CPU; a storage portion 42 consisting of a main storage device, such as a ROM or a RAM, and an auxiliary storage device, such as a flash memory, an HDD, or an SSD; an operation input portion 43 consisting of a touchscreen, a keyboard, a microphone, etc.; a display portion 44 consisting of a liquid crystal display or an organic EL display; and a communication portion 45 consisting of a communication module or a communication interface. Each of the player terminals 40 also executes various kinds of processing in accordance with programs stored in the storage portion 42. In addition, each of the player terminals 40 receives information from the server 20 by means of the communication portion 45 and transmits information to the server 20 and the other player terminals 40.

The information processing system 10 of this embodiment has a function for providing, via the player terminals 40, a game in which characters created by using racehorses as motifs are trained and the trained characters are entered to races to compete against other characters. In particular, the information processing system 10 of this embodiment has a training function for training the characters and an event function for organizing a team and competing against other teams, and, in the following, a case in which these functions are realized mainly by each of the player terminals 40 will be described. However, the above-described functions may be realized mainly by the server 20 or may be realized by dividing the functions between the server 20 and the player terminals 40.

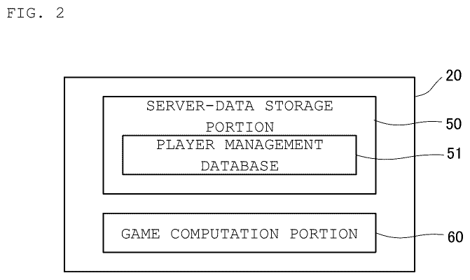

FIG. 2 is a functional block diagram showing major functions of the server 20.

The server 20 in the information processing system 10 has: a function for managing players, the characters, etc., by means of various kinds of identification information; and a function for performing computations required for the game progression in response to requests from the player terminals 40 and transmitting computation results to the player terminals 40, and these functions are realized by cooperations between a server-data storage portion 50 and a game computation portion 60.

The server-data storage portion 50 includes a player management database 51 and is mainly realized by means of the storage portion 22. In this embodiment, the player management database 51 stores a character list, an item list, and a training target list in association with a player ID of each of the players.

The character list includes, for example, character individual IDs given to respective trained characters, character classification IDs indicating the classification of the characters, the statuses (the rarity, the evaluation points, the course aptitudes, the distance aptitudes, the running style aptitudes, the running style, the speed, the stamina, the power, the guts, the intelligence, the possessed skills, and the acquired titles) of the characters, the lock state (locked or unlocked), the training history (training conditions and record of races entered during training) of the characters, etc.

The “trained characters” in this embodiment refer to characters that are trained by means of a training function, which is one of game functions realized by the information processing system 10 of this embodiment and for which the statuses thereof are confirmed as a result of completing said training.

In addition, this embodiment includes the “character individual IDs” and the “character classification IDs”, and the differences therebetween are as follow.

First, the “character individual IDs” are IDs given to the characters, for which the training by means of the training function has been completed, when said trained characters are registered in the player management database 51 and distinguish the respective trained characters associated with the player IDs.

In addition, this embodiment is configured such that a player selects a training target from the plurality of types of characters in the training function, and the “character classification IDs” are IDs given to distinguish the types of trained characters.

In addition, the “lock state” indicates whether or not transfer (deletion from the character list) of the trained characters is prohibited, and the transfer is allowed when the lock state is “unlocked” and the transfer is not allowed when the lock state is “locked”. Situations in which the lock state is “locked” include a case in which the player has individually specified the trained characters from a list thereof, a case in which the trained characters are registered to enter a race, etc.

The training target list stores data in which information indicating “released” or “unreleased” is associated with each of the character classification IDs. In this embodiment, the characters associated with the information indicating “released” in the training target list can be selected by the player as training targets in the training function. In addition, in this embodiment, new characters can be released by means of a release item and a character acquisition lottery, the number of characters that can be selected as the training targets vary depending on the players. In the following, the characters that can be selected as the training targets in the training function will be referred to as the released characters in some cases.

The item list includes data related to items, enhancement points, in-game currency that the player possesses. In this embodiment, for example, the possession specifics and the possessed amounts of the items, the possessed amounts of the enhancement points, the possessed amount of the in-game currency, etc. are stored in the player management database 51 as the item list.

The items in this embodiment are used to, for example, support the training of the characters and change entry conditions of a race, and are acquired in accordance with race results and acquired by using the in-game currency.

In addition, the enhancement points are used to, for example, enhance support items, which are items that support the training of the characters, and the characters can be trained in a more advantageous training environment as the support items are enhanced to a greater degree.

In addition, the data stored in the player management database 51 include a friend list. In this embodiment, by registering the other players in friend registration, the characters and the support items can be rented from the other players in the friend registration to be utilized in the training function. In the friend registration, when the player IDs of the other players are input on a friend registration screen displayed on the display portion 44 in the player terminal 40, in the case in which the players corresponding to said player IDs exist and the friend registration of said players is allowed, the player IDs of the other players selected as the registration targets are added to the friend list by performing tapping input on a registration button provided on the friend registration screen. There is an upper limit (for example, 50) for the number of friend registration for each of the players and there is an upper limit (for example, 100) for the number of friends that can be registered for each of the players; therefore, a new friend registration is allowed in a situation in which both of the upper limits are not reached.

In addition, the player management database 51 also stores data of the respective players related to an event function for organizing a team and competing against other teams. For example, team organization information of the respective players, results of matching among the players with each other, etc. are stored. In particular, in this embodiment, it is possible to organize a team by recruiting the trained characters of the other players in a team organizing event provided in the event function, and, regarding the trained characters of the other players incorporated into the player team, the character classification IDs and the statuses of said trained characters are saved in the player management database 51 in association with the player IDs, and some information items, such as factor information of the characters, inheritance character information, organization information of the support items, and information about the record of races entered during training, are excluded from saving targets. Also, in the case in which it is necessary to refer to the statuses of the characters affiliated with the team, such as a case in which the player enters an event race in the event function, processing for a running simulation is executed by referring to the statuses saved in the player management database 51. Accordingly, regarding the data of the trained characters of the other players incorporated into the team, even in the case in which the other players who trained said characters have deleted the data thereof, various kinds of processing related to the event function can be executed on the basis of the information saved in the player management database 51.

The game computation portion 60 (an example of an additional-status application portion) performs processing for performing computations required for the game progression in response to the requests from the player terminal 40 and transmitting the computation results to the player terminal 40, processing for transmitting data required for the game progression in response to the request from the player terminal 40 to the player terminal 40, etc., and is realized mainly by means of the control portion 41 and the communication portion 45. For example, upon receiving a request related to training instructions from the player terminal 40 in the training function, the game computation portion 60 computes a result indicating whether or not the training succeeds or fails and transmits the computation result to the player terminal 40. In addition, for example, upon receiving a request related to the race entry in the training function or the event function, the game computation portion 60 performs a running simulation for a race by a plurality of characters and transmits the running simulation result to the player terminal 40. In particular, in the case in which a request related to the race entry in the event function is received, the game computation portion 60 extracts competition opponent candidates on the basis of the team organization information of the respective players stored in the player management database 51 and transmits the extraction result to the player terminal 40 that is the origin of the request transmission. In addition, when a running simulation for a race in the event function is performed, the running simulation is executed by equally applying additional statuses acquired by the player to the characters affiliated with the team.

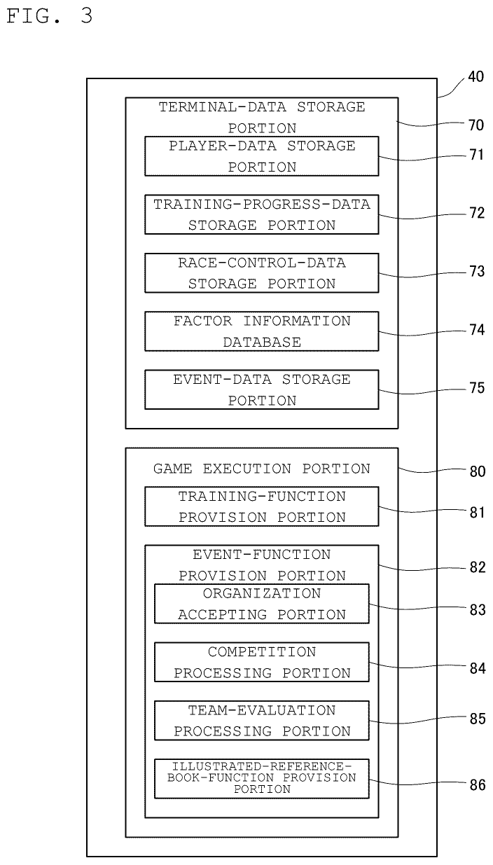

FIG. 3 is a functional block diagram showing major functions of the player terminal 40.

As shown in FIG. 3, in the player terminal 40 in the information processing system 10 of the embodiment, a terminal-data storage portion 70 and a game execution portion 80 cooperate to realize the training function, the event function, etc.

The terminal-data storage portion 70 stores data for the game execution portion 80 to perform various kinds of processing and is mainly realized by means of the storage portion 42.

The terminal-data storage portion 70 includes a player-data storage portion 71 and the player-data storage portion 71 stores, among others, data related to the character list, the training target list, the item list, and the friend list corresponding to the player ID. In this embodiment, synchronizing processing regarding the data (the character list, the training target list, the item list, and the friend list) associated with the player ID between the player-data storage portion 71 of the player terminal 40 and the player management database 51 of the server 20 is performed when an application is launched and ended and in other necessary situations, and various kinds of game processing are executed by utilizing the data stored in the player-data storage portion 71. In this embodiment, in the case in which the character list, the training target list, the item list, and the friend list need to be changed in association with the execution of the various kinds of game processing, the stored contents of the player-data storage portion 71 are updated, the updated stored contents are backed up in the player management database 51 of the server 20, and the stored contents are synchronized therebetween. Note that, the data associated with the player ID, such as the character list, the training target list, the item list, and the friend list, may be downloaded to the player-data storage portion 71 from the player management database 51, as needed, in such a situation as when the application is launched.

In addition, the terminal-data storage portion 70 includes a training-progress-data storage portion 72 and the training-progress-data storage portion 72 stores data (training progress data) required for the progression of the training function for the characters (the characters having the character classification IDs associated with the information indicating “released” on the training target list) that can be selected as the training targets in the training function. In this embodiment, with regard to the training function, training goals and game events are provided for each of the characters, and the training-progress-data storage portion 72 stores the training progress data, which at least include the setting specifics of the training goals and the setting specifics of the game events, associated with the character classification IDs.

In addition, the terminal-data storage portion 70 includes a race-control-data storage portion 73 and the race-control-data storage portion 73 stores, among others, data for controlling, when viewing a race in which the characters are entered in the training function and the race competition function, motions of characters and visual effects of skill activations and text data and voice data for live commentary for the race.

In addition, the terminal-data storage portion 70 includes a factor information database 74 and the factor information database 74 stores information, such as the factor name, the factor level, and the factor type, in association with factor registration IDs. The factor information is information associated with the trained characters when the characters are trained via the training function. In this embodiment, when the characters are trained via the training function, factor inheritance events occur as game events for status enhancement that affects the abilities of the training target characters, such as increasing the skill acquisition level and increasing performance parameters, on the basis of the factor information associated with the trained characters selected as inheritance characters.

There are four kinds of factor information, namely, blue factors, red factors, unique factors, and white factors. In each kind of the factor information, three stages of factor level are set so that advantageous effects for the status enhancement are obtained as the factor level increases. In addition, the factor types are for finely classifying the blue factors, the red factors, the unique factors, and the white factors. The blue factors are the factor information referred to by the names of the performance parameters, affect the performance parameters, and increase the performance parameters by greater amounts as the factor level thereof increases. The red factors are the factor information referred to by the names of the course aptitude, the distance aptitude, or the running style aptitude, affect the course aptitude, the distance aptitude, or the running style aptitude, and facilitates an increase in the aptitude in the factor inheritance event as the factor level thereof increases. The unique factors are the factor information referred to by the names of the unique skills, make it possible to acquire the unique skills of inheritance characters, and facilitate an increase in the acquisition level of the unique skills as the factor level thereof increases. The acquisition level of a skill affects the use amounts of skill points when the skill is acquired, and the use amounts of the skill points decrease as the acquisition level increases. The white factors are the factor information that do not belong to any of the blue factors, the red factors, and the unique factors and include skill factors, race factors, and scenario factors. The skill factors are the factor information referred to by the names of the skills, facilitate an increase in the acquisition level of normal skills (skills other than the unique skill), and exist for each skill type. The race factors are the factor information referred to by the names of races or racetracks, facilitate increases in at least one of the performance parameters and the acquisition level of the normal skills, and have different effects in accordance with race types or racetrack types. The scenario factors are the factor information referred to by the names of training scenarios and relates to training scenarios through which the characters are trained. In the case in which the scenario factors are inherited in the factor inheritance event, it is possible to significantly increase a plurality of performance parameters, and the performance parameters that increase are different depending on scenario factor types. In addition, with the above-described factor types, the factor information is classified into six types, namely, the blue factors, the red factors, the unique factors, the skill factors, the race factors, and the scenario factors.

In addition, the terminal-data storage portion 70 includes an event-data storage portion 75 and the event-data storage portion 75 stores, regarding a team organizing event held for a limited period, data related to the event period of the event, data for controlling the progression of the event, and various kinds of data managed for each of the players, among others. In particular, in this embodiment, an illustrated-reference-book function for registering the characters that have satisfied registration conditions in the team organizing event is provided and the event-data storage portion 75 stores illustrated reference book data for managing a character registration status, an additional-status acquisition status, etc. in the illustrated-reference-book function.

The game execution portion 80 performs: processing for starting a game in the case in which a game start condition is satisfied; processing for executing a game mode selected from a plurality of types of game modes; processing for progressing the game; processing for causing an event to occur in the case in which an event occurrence condition is satisfied; processing for computing a game result; processing for ending the game in the case in which a game ending condition is satisfied; processing for requesting the server 20 to perform a computation; processing for acquiring the computation result and required data from the server 20; and processing for transmitting the computation result and data in the player terminal 40 to the server 20, and is mainly realized by means of the control portion 41 and the communication portion 45. In this embodiment, the game execution portion 80 includes a training-function provision portion 81 and an event-function provision portion 82.

The training-function provision portion 81 performs processing for providing the training function for training the characters. In this embodiment, said processing includes accepting an input regarding the character training, displaying a computation result with respect to said input, etc.

In this embodiment, when the characters are trained via the training function, the player is prompted every turn to select a turn-use subject action. The turn-use subject actions include training, race entry, outing, using infirmary, etc., and the training-function provision portion 81 accepts the selection of the turn-use subject action via a training home screen or the like displayed in the display portion 44 and requests the server 20 to perform a computation for obtaining the result with respect to the selected action. Upon receiving the request, the server 20 performs the computation for obtaining the result with respect to the selected action and transmits the computation result to the player terminal 40, and the training-function provision portion 81 causes the display portion 44 to display a display screen corresponding to the computation result received from the server 20.

In addition, in this embodiment, a training goal is set in accordance with the classification of the training target character, and there are cases in which the training goal includes an essential action that is forcedly selected in a prescribed turn. For example, the training goal includes entering a prescribed race or achieving a prescribed arrival order as a result of the prescribed race. In this case, in the turn in which the prescribed race associated with the training goal is set, race entry is set to be the essential action and turn-use subject actions other than the race entry cannot be selected. Accordingly, the training-function provision portion 81 performs control for restricting the selection of actions that are different from the essential action in the turn in which the selection of the essential action is accepted.

The event-function provision portion 82 performs processing for providing an event function for enhancing a team organized by the player. In this embodiment, it is possible to hold, for a limited period, a team organizing event in which, in the case in which the player organizes a team consisting of a plurality of types of characters, competes against other teams, and wins the competition, the team is reinforced by recruiting a character from a competition opponent team to replace a character affiliated with the team. In other words, various kinds of functions provided with regard to the team organizing event are enabled only during the event period. Also, the event-function provision portion 82 includes an organization accepting portion 83, a competition processing portion 84, a team-evaluation processing portion 85, and an illustrated-reference-book-function provision portion 86.

The organization accepting portion 83 performs processing for accepting inputs for selecting the characters to be used in the team organizing event from the plurality of types of characters and organizing the team. In this embodiment, in the team organizing event, it is possible to organize a team consisting of a total of seven characters including one captain and six members.

The organization accepting portion 83 performs processing for accepting the selection of a character to be the captain from among the trained characters that the player possesses. Regarding the members, supporting characters provided in advance are allocated as initial members. In the team organizing event, when a competition is won, it is possible to recruit one character from the competition opponent team and replace a member of the player team with said character. Note that, in this embodiment, it is not possible to recruit a character from the competition opponent team in the case in which the competition in the team organizing event is lost. However, it may be possible to recruit a character from the competition opponent team even in the case in which the competition in the team organizing event is lost. The organization accepting portion 83 performs processing for, in the case in which the competition in the team organizing event is won, accepting the selection of a recruitment target character from the seven characters affiliated with the competition opponent team and accepting the selection of a replacement target character from the six members affiliated with the player team. Note that, in this embodiment, even in the situation in which the competition in the team organizing event is won and it is possible to recruit a character from the competition opponent team, whether or not to perform the replacement with a member of the player team is optional for the player, and it is also possible not to recruit a character from the competition opponent team.

In addition, in this embodiment, it is necessary to use recruitment points when recruiting a character from the competition opponent team. Accordingly, there are cases in which it is not possible to recruit a desired character from the competition opponent team because the player does not possess enough recruitment points. Therefore, in a situation in which a character is recruited from the competition opponent team, a character planned to be recruited from the characters affiliated with the competition opponent team may be specified and the planned-recruitment-character specifying information may be carried over until the next and subsequent recruiting opportunities. In the case in which planned-recruitment-character specifying information is carried over, not only a character affiliated with the competition opponent team in the current competition, but also a planned-recruitment-character affiliated with the competition opponent team in the past competition may be allowed to be selected as the recruitment target. In this case, when the planned-recruitment-character is incorporated into the team as a result of being replaced with a character affiliated with the player team as the recruitment target, the planned-recruitment-character specifying information is cleared. Note that an upper limit number may be set regarding the planned-recruitment-characters or a specifying-information saving period (for example, effective until next recruitment, etc.) may be set.

The competition processing portion 84 (an example of an additional-status application portion) performs processing related to the competition between the player team and the competition opponent team. In this embodiment, in the team organizing event, the competition processing portion 84 acquires matching results of three teams serving as competition opponent candidates from the server 20 and accepts the selection of the competition opponent by the player on the basis of the matching results. In addition, when the competition opponent is determined, the competition processing portion 84 performs processing for acquiring the result of a running simulation between the player team and the competition opponent team from the server 20 and causing the display portion 44 to display the state of the competition and the competition result on the basis of the result of the running simulation.

In this embodiment, additional statuses in accordance with the registration statuses of an illustrated reference book, described later, are applied in the competition between the teams with each other in the team organizing event. The additional statuses include performance increase bonuses and team skills, wherein the performance increase bonuses equally apply effects of increasing the performance parameters to the characters affiliated with the team and the team skills are skills that are equally applied to the characters affiliated with the team. Note that, in this embodiment, on the display screen related to the event race in which the teams compete with each other, the statuses that are individually set to the characters and the additional statuses (the performance increase bonuses and the team skills) are displayed in a distinguishable manner. For example, in the case in which the original speed of the characters is “100” and a performance increase bonus of “+20” is applied thereto, the status specifics are displayed in the form of “100+20” on a status confirmation screen before viewing a race movie of the event race. In addition, for example, in the case in which a team skill is applied to the characters, skills that the characters individually possess are normally displayed and the applied team skill is displayed in an emphasized manner on the status confirmation screen before viewing a race movie of the event race. In addition, in the case in which the team skill is activated in the race movie of the event race, an activation display of the skill is shown in a more emphasized manner than the cases in which the skills that the characters individually possess are activated.

In addition, in this embodiment, the teams compete with each other by entering the event race in the team organizing event. It is necessary to use the entry items in order to enter the event race, the competition processing portion 84 allows the entry to the event race in a situation in which the entry items can be used. The event-data storage portion 75 manages the possessed number of the entry items.

The team-evaluation processing portion 85 (an example of an additional-status application portion) calculates team evaluation points indicating the team evaluation on the basis of the team organization information of the player and determines the team rank in accordance with the team evaluation points. In this embodiment, the team evaluation points are calculated as the sum of evaluation points based on the statuses of the seven characters affiliated with the team organized by the player and the team rank is determined on the basis of the team evaluation points. A plurality of stages are set for the team rank in accordance with the amount of team evaluation points and threshold values for determining the respective stages of the team rank are set. The team-evaluation processing portion 85 compares the calculated team evaluation points with the threshold values of the respective stages to determine the team rank to which the team corresponds. Note that, in this embodiment, the additional statuses (the performance increase bonuses and the team skills) in accordance with the registration statuses of the illustrated reference book are also applied to the calculation of the team evaluation points. However, an embodiment in which the additional statuses in accordance with the registration statuses of the illustrated reference book are not applied to the calculation of the team evaluation points may be employed.

The illustrated-reference-book-function provision portion 86 (an example of an additional-status setting portion) performs processing for registering the characters that have satisfied a registration condition to the illustrated reference book and allowing the registered contents of the illustrated reference book to be viewed via the display portion 44. In this embodiment, when the player team wins the competition against the competition opponent team in the team organizing event, characters that are not registered in the illustrated reference book among the characters affiliated with the player team are registered in the illustrated reference book. In the case in which the player team wins the competition in the team organizing event, the illustrated-reference-book-function provision portion 86 determines whether or not there is a character that is not registered in the illustrated reference book among the characters affiliated with the player team by referring to character roster information in the illustrated reference book data stored in the event-data storage portion 75 and, in the case in which there is a character that is not registered in the illustrated reference book, updates the character roster information of the illustrated reference book data by using said character as a registration target.

In addition, in this embodiment, when the player team wins the competition against the competition opponent team in the team organizing event, if the combination of the characters affiliated with the player team is a specific combination, a team skill is registered in the illustrated reference book in an acquired state. In the case in which the player team wins the competition in the team organizing event, the illustrated-reference-book-function provision portion 86 determines whether or not the combination of the characters affiliated with the player team satisfies an acquisition condition of a team skill that is in an unacquired state in the illustrated reference book by referring to team skill information in the illustrated reference book data stored in the event-data storage portion 75 and, in the case in which there is a team skill for which the acquisition condition is satisfied, updates the team skill information in the illustrated reference book data by using said team skill as an acquisition target.

In addition, the illustrated-reference-book-function provision portion 86 sets illustrated reference book bonuses in accordance with the registration status of the illustrated reference book in association with the player ID. In this embodiment, as the illustrated reference book bonuses, the performance increase bonuses, the team skills, and the point increase bonuses can be set. Note that, in this embodiment, the server 20 also manages the information related to the illustrated reference book bonuses and the player management database 51 stores the illustrated reference book bonuses as the information associated with the player ID. Also, when entering the event race in the team organizing event, the running simulation is executed by referring to additional status information including the performance increase bonuses and the team skills associated with the player ID in the player management database 51.

The performance increase bonuses impart effects of increasing the performance parameters to the respective characters affiliated with the team organized by the player. In this embodiment, for each character type, the performance parameters to be increased and the increase amounts thereof are set in advance.

The team skills are imparted to the respective characters affiliated with the team organized by the player. In this embodiment, different team skills are set in advance for the respective combinations of the characters.

The point increase bonuses impart effects of increasing the acquired amount of the recruitment points, which are used to recruit a character from the competition opponent team in the team organizing event. In this embodiment, the point increase bonuses are set in advance in accordance with the number of characters registered in the illustrated reference book, and the acquired amount of the recruitment points increases as the registered number increases. Note that, in this embodiment, the point increase bonuses are also applied in accordance with the number of consecutive wins in the event race, separately from the illustrated reference book bonus.

2. Control Method of this Embodiment

In the following, a control method of this embodiment will be described in terms of an example in which the game program of this embodiment is applied to a game application in the player terminal 40 provided in the form of a smartphone.

The game program of this embodiment is configured so as to be capable of providing a plurality of types of game functions, and, in the training function, which is the principal game function, training target characters are selected from the plurality of types of characters, the statuses thereof change in accordance with the game progression, and, when a prescribed ending condition is satisfied, the character statuses are confirmed and the training ends. Said trained characters can compete against characters trained by the other players in a race in the team organizing event provided via the event function, which is another game function. In addition, in this embodiment, a possession capacity (the number of trained characters that can be registered in the character list) is set in advance for the trained characters, and, when the upper limit (for example, 240) of the possession capacity is reached, new characters cannot be trained in the training function. Accordingly, the trained characters need to be deleted from the character list to ensure that there is adequate possession capacity.

With the information processing system 10 to which the game program of this embodiment is applied, the event function provides the team organizing event for a limited period. The team organizing event is configured such that the player organizes a team consisting of the plurality of types of characters and aims to enhance the team. Specifically, the team organized by the player and teams organized by other players compete in a race, and, in the case in which the competition is won, the team can be enhanced by recruiting a character from a competition opponent team and replacing a character affiliated with the player team with said recruited character. In this embodiment, the team evaluation points and the team rank are provided as indicators of the degree of team enhancement, and, in the team organizing event, achievement rewards can be obtained by achieving a greater amount of the team evaluation points and a higher team rank.

Here, the training function for training the characters will be described as a premise for describing the event function.

In the training function, one character that serves as a training target is arbitrarily selected by the player from the plurality of types of characters and said character is trained. For the plurality of types of characters that can be selected as the training target, initial statuses are set in accordance with character types. In addition, the character that serves as the training target has a skill (unique skill) unique thereto in accordance with the character type from the beginning of the training, and the activation condition and the effect imparted when being activated are different for each unique skill. In addition, for the plurality of types of characters that can be selected as the training target, growth correction rates for the performance parameters, such as the speed, the stamina, the power, the guts, and the intelligence, are set in accordance with the characters, and parameters that easily increase are set for each of the character types. In addition, for the training target character, statuses related to aptitude ranks, such as the course aptitude (grass and dirt), the distance aptitude (short distance, mile, middle distance, and long distance), running style aptitude (front runner, stalker, midfield, and closer) are also set in accordance with the character types, and, as the aptitude ranks increase, more advantageous effects are imparted when entering a race.

When the training target is selected and the character training starts, the character can be trained by giving a training instruction in each turn for a maximum of 75 turns. Specifically, when a training instruction associated with a performance parameters, such as the speed, the stamina, the power, the guts, or the intelligence, is given, the performance parameters change and skill points are acquired in accordance with the training result. In addition, one turn can be used by giving a race entry instruction, and it is possible to change the performance parameters and acquire the skill points in accordance with the race result. In addition, when an event occurrence condition is satisfied during the training, an event occurs and the types of skills that can be acquired increase and the performance parameters change. The skill points, which have already been described, are used to allow the training target character to acquire skills, and it is possible to acquire skills from an acquirable skill list by using the possessed skill points.

In addition, in the character training, a plurality of training goals are set for each character in accordance with the type of training target character. The training goals include entering a target race, achieving a result of a prescribed arrival order or higher in the target race, acquiring a prescribed number of fans before arriving at a prescribed turn, etc. In this embodiment, it is possible to acquire a number of fans in accordance with the arrival order when a character being trained enters a race, and an entry condition based on the number of fans is set for each race.

In addition, in this embodiment, the plurality of training goals set for each character are set in the turns up to the 72nd turn, and the 73rd to 75th turns are for last races. The last races, namely, a qualifying race, a semi-final race, and a final race, are conducted over the three turns, and it is possible to give a training instruction before entry to each of the races.

In addition, in this embodiment, a continue function is provided as a relief function when the result of a specified arrival order or higher is not achieved in the case in which the training goal of achieving a result of a prescribed arrival order or higher in the target race is set in the character training. The continue function provides an opportunity to retry the target race, and it is possible to retry the target race by using a number of continues given to the player in advance. In this embodiment, the number of continues is set to be three over the course of training one character.

Also, in the training game function, a transition to a training-ending confirmation state occurs when any one of a plurality of types of ending conditions set in advance is met.

First, in the case in which the final race of the last races is reached, in other words, the 75th turn is reached, the training ends in association with the end of the final race. Note that, in the case in which the result of the final race is the second place or lower, retry is possible if there is remaining number of continues, and, in the case in which the result of the final race is the second place or lower after all of the number of continues are used up, the training ends at that point in time. In addition, whether or not to use the continue function is up to the player, and, in the case in which the player selects not to utilize the continue function, the training ends at that point in time.

In addition, the training also ends in the case in which the training goals set for each character are not achieved in the turns up to the 72nd turn.

For example, in the case in which the training goal is to acquire a prescribed number of fans, the training ends as a result of failing to reach the number of fans set in the turn set in the training goal. Because the continue function cannot be utilized in this case, the training ends as a result of failing to reach the prescribed number of fans when the determination target turn is reached.

In addition, for example, in the case in which the training goal is entering a target race, the training goal is achieved regardless of the arrival order in said race so long as the entry to the target race is achieved; however, it is necessary to have acquired the number of fans that serve as the entry condition set for each race, and, in the case in which the number of fans serving as the entry condition of the target race has not been acquired in the turn of said race, it is not possible to enter the target race, and thus, the training ends.

In addition, for example, in the case in which the training goal is achieving a prescribed arrival order or higher in a target race, if the entry condition of the target race is not met, the training ends at that point in time, and, even if the entry to the target race is achieved, the training ends in the case in which the prescribed arrival order or higher is not achieved and there is no remaining number of continues. Note that, as has already been described, the player can arbitrarily select whether or not to utilize the continue function, it is considered that the training goal is not achieved in the case in which the player selects not to utilize the continue function even if there is remaining number of continues, and thus, the training ends.

In addition, in the case in which the game has progressed to the 73rd turn or later, it is possible to advance to the subsequent turn by respectively achieving the first place in the qualifying race and the semi-final race of the last races, and the training ends in the case in which the result is the second place or lower and there is no remaining number of continues. In this case also, if the player selects not to utilize the continue function, the training ends at that point in time.

Also, in this embodiment, the transition to the training-ending confirmation state occurs when the training ending conditions are met. The training-ending confirmation state provides the last opportunity for the skill acquisition before the status confirmation, and the player can acquire skills by using the skill points in possession at that point in time. In addition, in the training-ending confirmation state, an input interface for inputting training ending confirmation is provided, and, when the player inputs the training ending confirmation, the statuses of the training target character are confirmed, and the information related to said character is registered in the character list in the player-data storage portion 71 and the character list in the player management database 51 as a trained character.

When the statuses of the training target character are confirmed via the training-ending confirmation state, training rewards in accordance with trainings results are provided. In this embodiment, the in-game currency and the enhancement points in accordance with the number of fans acquired by the end of the training are provided as the training rewards.

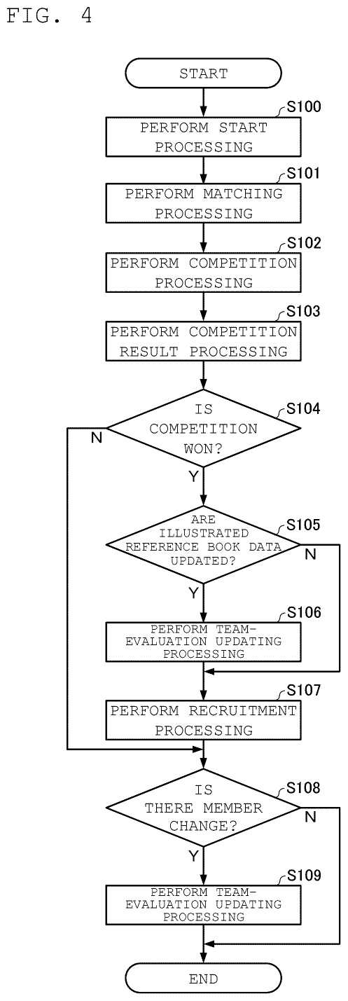

Also, in this embodiment, the trained characters for which the statuses are confirmed via the training function can be used in the team organizing event provided by the event function. In the following, the game progression in the team organizing event provided by the event function will be described in detail in accordance with the flowchart shown in FIG. 4.

First, start processing for accepting the start of the team organizing event is performed (step S100). When the team organizing event is executed for the first time, the selection of a character that will serve as the captain of the team from the trained characters that the player possesses is accepted. In the team organizing event, only a trained character that the player possesses can be set to be the captain of the player team. Supporting characters prepared in advance when executing the team organizing event for the first time are set to be the six characters that serve as the members, which are the characters other than the captain affiliated with the team. The same combination of the six characters related to the supporting characters is set to all players. However, a plurality of types of combinations may be provided for the six characters related to the supporting characters and one type of combination may be randomly determined by a lottery or the player may be allowed to select one of the combinations when the team organizing event is started.

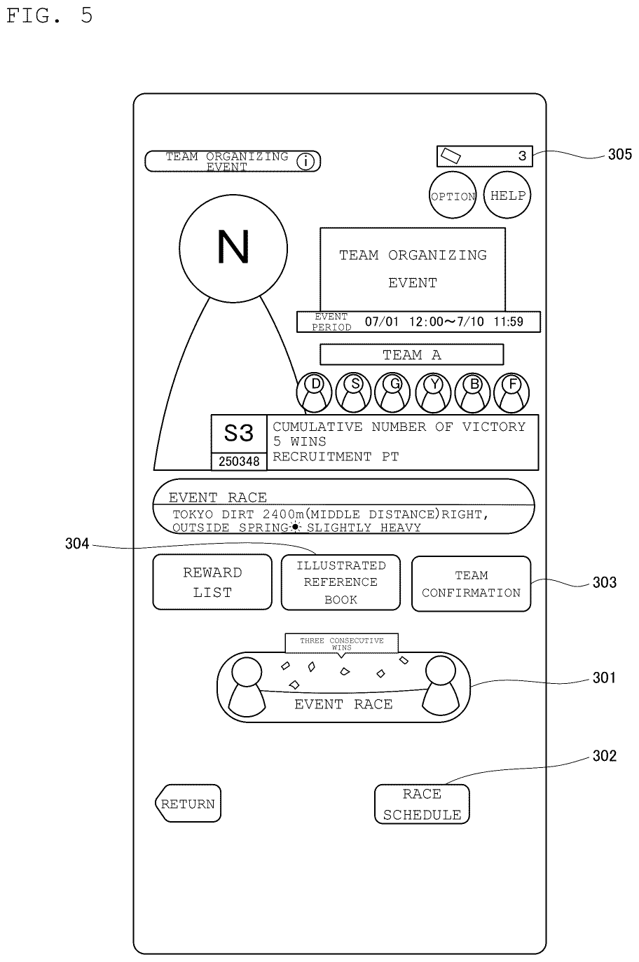

The team organization is completed when the player determines the character that will serve as the captain, the team evaluation points based on the statuses of the seven characters affiliated with the team consisting of the captain and the members are calculated, and the team rank based on the team evaluation points is determined. In this embodiment, as a result of the team rank increasing in the team organizing event, rank achievement rewards in accordance with the achieved team rank are given. In addition, when the team organization is completed, the display screen transitions to an event top screen on which the entry to the event race is accepted, as shown in FIG. 5.

The event top screen is provided with a matching button 301, and, when a tap input is performed on the matching button 301, matching processing is executed (step S101). Specifically, a matching request is transmitted to the server 20 from the player terminal 40, and, upon receiving the matching request, the server 20 extracts competition opponent candidates and transmits the competition-opponent-candidate extraction result to the player terminal 40. Note that, because this embodiment is configured such that the player can change the team captain after confirming the competition opponent candidates, the server 20 holds the competition-opponent-candidate extraction result, even after the extraction result is transmitted to the player terminal 40.

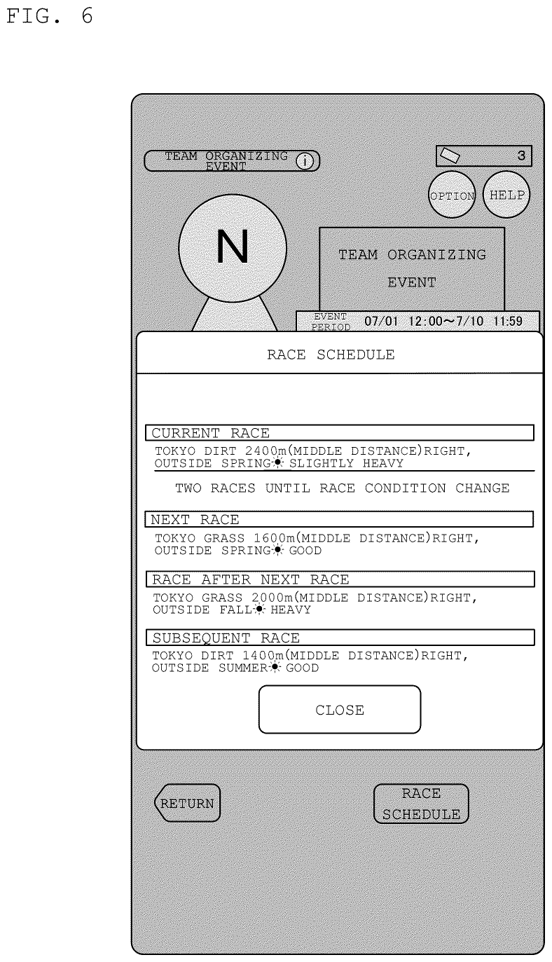

In addition, the event top screen is provided with a race schedule confirmation button 302, and, when a tap input is performed on the race schedule confirmation button 302, a race-schedule confirmation dialog is displayed, as shown in FIG. 6. In the race-schedule confirmation dialog, it is possible to confirm races that are scheduled to be held in the future, including the ongoing races. In this embodiment, it is possible to confirm the races that are scheduled to be held in the race-schedule confirmation dialog as a reference when organizing the team. The race-schedule confirmation dialog is provided with a close button 306, and, when a tap input is performed on the close button 306, the race-schedule confirmation dialog is closed and the event top screen is restored. Note that, as an embodiment of the event race, three races may be defined as one cycle, one cycle may end when races of the same course and the same distance are held three times, and races in which at least one of the course and the distance is different may be held as the next cycle. In this case, the weather (sunny, rain, etc.) and the course condition (good, heavy, etc.) in the same cycle may randomly be determined by a lottery or may be determined in advance.

In addition, in this embodiment, it is necessary to use the entry items to enter the event race, and the number of entry items that the player possesses can be confirmed in a possessed-number-of-entry-item display field 305 on the event top screen, etc. shown in FIG. 5.

In the competition-opponent-candidate extraction based on the matching request, three teams are extracted with reference to the team evaluation points of the player team. In this embodiment, regarding two teams out of the three teams, teams of the other players having the team evaluation points for which the difference with respect to the team evaluation points of the player team is in the range of 0% to +10% are extracted. In addition, regarding the remaining one team out of the three teams, one of teams of the other players having the team evaluation points for which the difference with respect to the team evaluation points of the player team is in the range of −10% to 0% is extracted. Accordingly, in the matching processing, a total of three teams, namely, two teams that have equivalent or greater amounts of the team evaluation points relative to the player team and one team that has equivalent or smaller amounts of the team evaluation points relative to the player team, are extracted.

Note that, in the case in which there is no team that is appropriate as the extraction target, it is possible to expand the search range as exception processing. For example, in the case in which, among the teams of the other players, there is no team that has the team evaluation points for which the difference with respect to the team evaluation points of the player team is in the range of −10% to 0%, the extraction may be performed by expanding the search range to −20% to 0%, and, in the case in which, among the teams of the other players, there is no team that satisfies the condition, the search range may be further expanded to −30% to 0%. In addition, the three teams extracted by the matching processing may include a team prepared as a non-player character (NPC) team that is not a team organized by a real player.

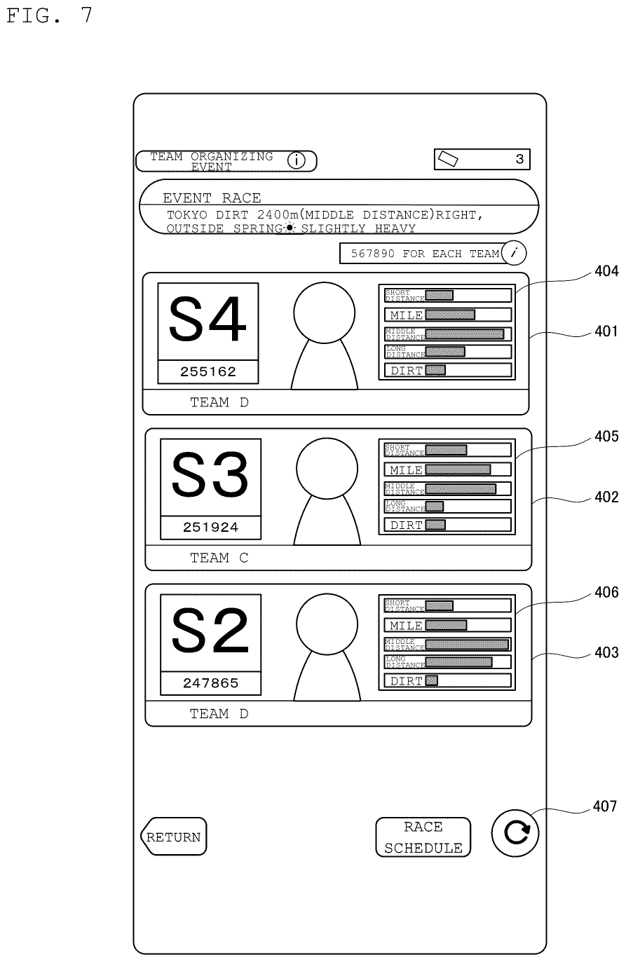

When the extraction of the three teams that will serve as the competition opponent candidates is completed by means of the matching processing in the server 20, a competition-opponent selection screen is displayed, as shown in FIG. 7, in the player terminal 40 that has received the competition-opponent-candidate extraction result from the server 20.

On the competition-opponent selection screen, team icons 401 to 403 of the three teams extracted as the competition opponent candidates are displayed in descending order from teams having greater amounts of the team evaluation points. Accordingly, on the competition-opponent selection screen, the teams corresponding to the team icons 401, 402 are teams having equivalent or greater amounts of the team evaluation points relative to the player team and the team corresponding to the team icon 403 is the team having an equivalent or smaller amount of the team evaluation points relative to the player team. Accordingly, in the case in which the player prioritizes winning the competition, the player would select a team having as small an amount of the team evaluation points as possible as the competition opponent, and, in the case in which the player aims to recruit a character having a high evaluation point to the player team, the player would select a team having as high an amount of the team evaluation points as possible as the competition opponent. Accordingly, when selecting the competition opponent in the team organizing event, there is a strategic element in anticipation of team organization after the competition.

The team icons 401 to 403 are respectively provided with team status display fields 404 to 406 based on the organization information of the respective teams. The team status visually displays the degree of team strength with regard to prescribed aptitude classifications in terms of gauge amounts. In this embodiment, regarding five types of aptitude classifications, namely, short distance, mile, middle distance, long distance, and dirt, the gauge amounts are calculated on the basis of the evaluation points and aptitude ranks of the seven characters affiliated with the team. In this embodiment, correction rates in accordance with the aptitude ranks are set, values obtained by multiplying the evaluation points of the characters by the correction rates are employed as the evaluation basic values, and the gauge amounts to be displayed as the team statuses are determined on the basis of the sum of the evaluation basic values of the seven characters affiliated with the team.

Note that, in the team status display fields 404 to 406, the aptitude classification gauge corresponding to the event race to be entered may be displayed in an emphasized manner. In addition, the aptitude classification gauge amounts are respectively calculated with reference to the aptitudes of the characters affiliated with the team; however, the plurality of types of aptitudes may be referred to for some of the aptitude classifications. For example, regarding the dirt aptitude classification, the gauge amount may be calculated with reference to not only the dirt aptitudes of the characters affiliated with the team, but also the distance aptitudes thereof. In addition, an upper limit value may be set to the evaluation points of the characters only when the gauge amounts of the respective aptitude classifications are calculated. By doing so, the influences of the differences among the evaluation points of the characters on the gauge amounts are reduced even if there is a character having an exceptionally high amount of the evaluation points among the characters affiliated with the team; therefore, the levels of the abilities of the team as a whole can easily be ascertained by means of the gauge amounts.

In addition, the competition-opponent selection screen is provided with a re-matching button 404, and, when a tap input is performed on the re-matching button 404, the player terminal 40 transmits a matching request, and the server 20 performs the matching processing again. Accordingly, in this embodiment, in the case in which the competition opponent candidates presented on the competition-opponent selection screen are changed, it is possible to request the matching processing to be performed again by utilizing the re-matching button 404.

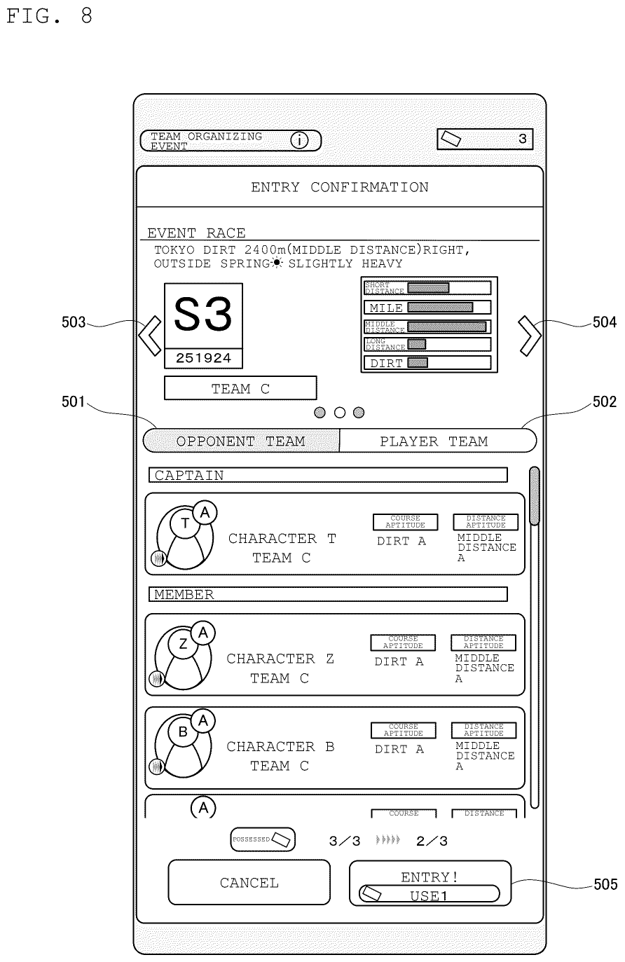

Also, when a tap input is performed on one of the team icons 401 to 403 on the competition-opponent selection screen, the display screen transitions to an entry confirmation screen, as shown in FIG. 8.

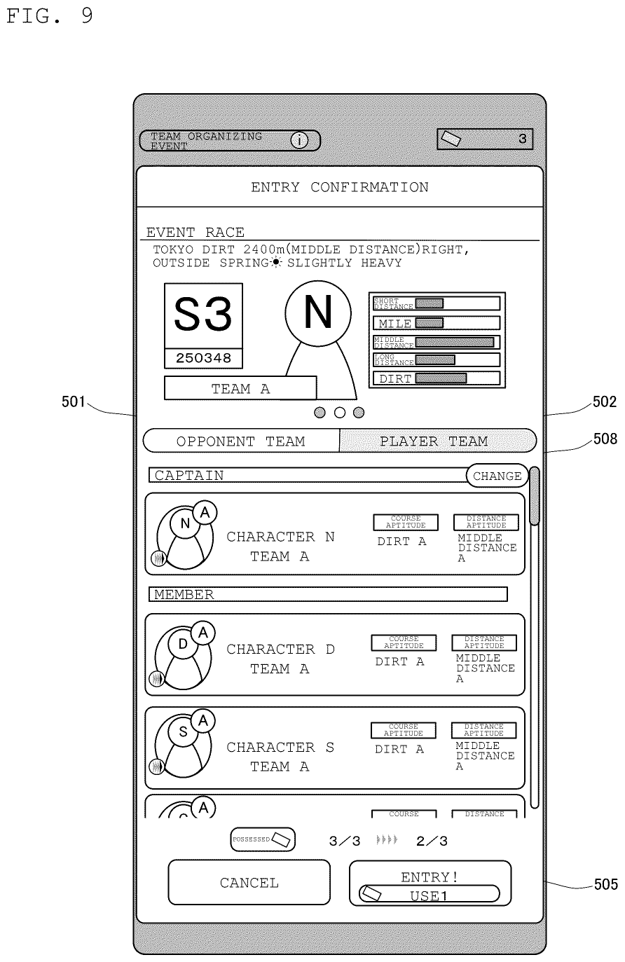

The entry confirmation screen is set to the state in which the team corresponding to the team icon on which the tap input is performed on the competition-opponent selection screen is selected as the competition opponent. In addition, on the entry confirmation screen, tab switching allows switching between displaying opponent team information and player team information. Specifically, as shown in FIG. 8, in the case in which the opponent team information is displayed, by tapping a tab 502, the player team information is displayed, as shown in FIG. 9. In addition, as shown in FIG. 9, in the case in which the player team information is displayed, by tapping a tab 501, the opponent team information is displayed, as shown in FIG. 8. Note that, in the case in which the opponent team information is displayed on the entry confirmation screen, the amounts of recruitment points required to recruit characters affiliated with the opponent team may be displayed for the respective characters.

In addition, on the entry confirmation screen, it is possible to change the competition opponent. Specifically, by using a left change button 503, the competition opponent can be changed to a team having a greater amount of the team evaluation points than the selected competition opponent, and, by using a right change button 504, the competition opponent can be changed to a team having a smaller amount of the team evaluation points than the selected competition opponent. Note that, in the state in which a team having the greatest amount of the team evaluation points is selected as the competition opponent, the input to the left change button 503 is disabled and the left change button 503 is displayed in a grayed-out manner on the entry confirmation screen, and, in a state in which a team having a smallest amount of the team evaluation points is selected as the competition opponent, the input to the right change button 504 is disabled and the right change button 504 is displayed in a grayed-out manner on the entry confirmation screen.

Also, when a tap input is performed on an entry button 505 on the entry confirmation screen, competition processing is executed (step S102). Specifically, a competition result request is transmitted to the server 20 from the player terminal 40, and, upon receiving the competition result request, the server 20 executes a running simulation with a total of 14 characters consisting of the seven characters affiliated with the player team and the seven characters affiliated with the competition opponent team, and transmits the simulation result to the player terminal 40. In this embodiment, the entry items are used to enter the event race. The entry items are provided to each of the players at a certain time (four example, 12:00) every 24 hours. In addition, a possession upper limit is set to the entry items, the supplied entry items cannot be received in the case in which the possession upper limit is exceeded at the time of provision. In addition, the entry confirmation screen is provided with a captain change button 508, and the captain can be changed after confirming the organization specifics of the competition opponent team.

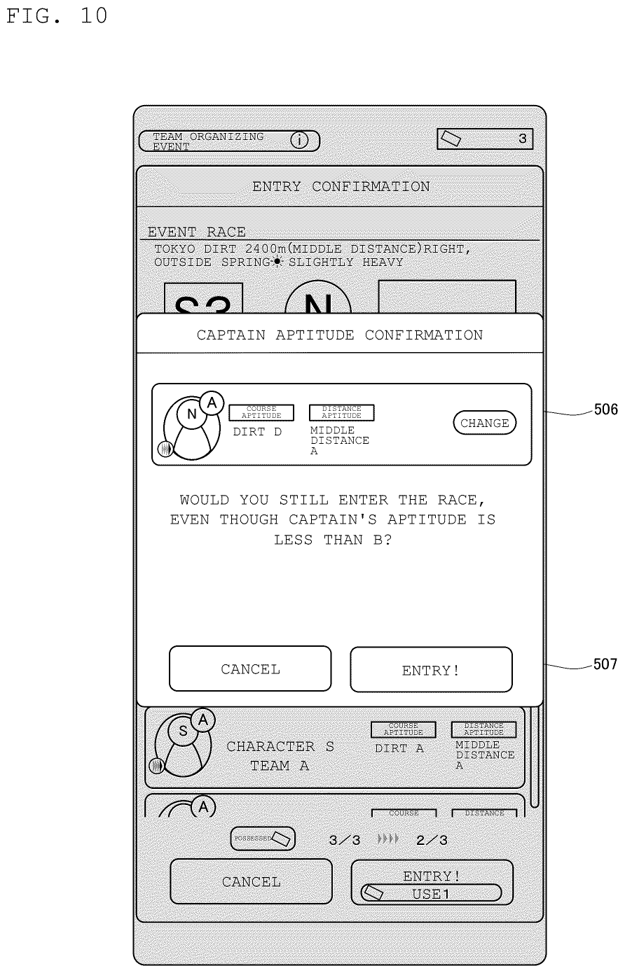

Note that, in the case in which a tap input is performed on the entry button 505 on the entry confirmation screen, the execution of the competition processing is put on hold in the case in which the aptitude of the captain of the player team is less than B rank, and an aptitude confirmation dialog is displayed, as shown in FIG. 10. The aptitude confirmation dialog is provided with a captain change button 506, and, when a tap input is performed on the captain change button 506, the character to be the captain can be changed. Accordingly, in this embodiment, the characters affiliated with the team sometimes include the characters whose distance aptitudes and course aptitudes are not suitable, and this provides a strategic element of building a team by taking such a situation into consideration. Also, in the case in which the aptitude confirmation dialog is displayed, the competition processing is executed when a tap input is performed on an entry button 507 in the aptitude confirmation dialog.

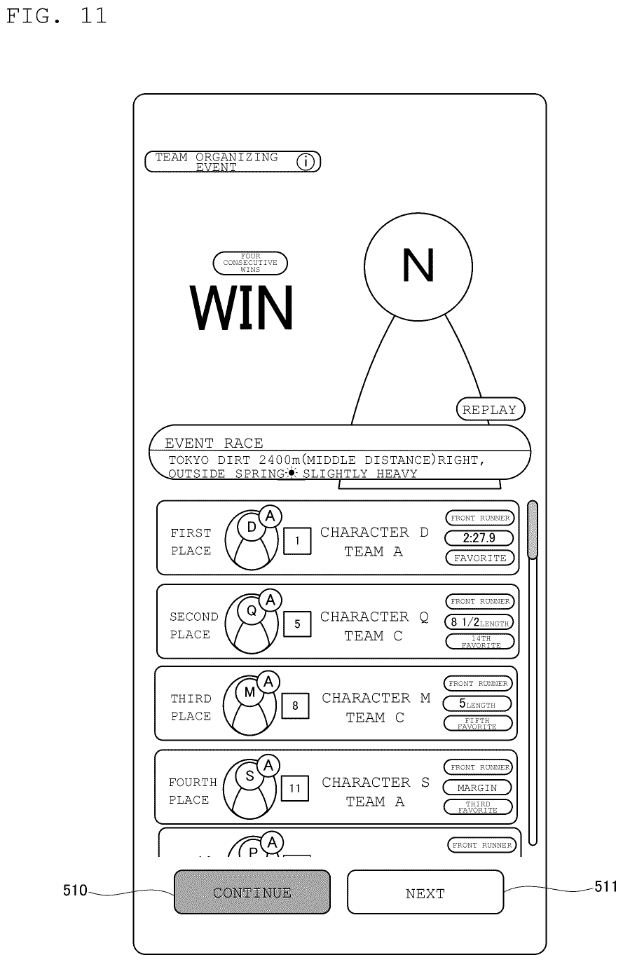

Upon receiving the simulation result from the server 20, the player terminal 40 performs competition result processing (step S103). First, a race movie showing the state of the race based on the simulation result is generated so as to allow the player to view the state of the race on the display screen. Then, when the race viewing ends, as shown in FIG. 11, the display screen transitions to a competition result screen, and the competition result is notified. The win/lose of the event race in the team organizing event is determined so that a team with which the character who achieves the first place is affiliated wins. In other words, the player wins in the case in which a character affiliated with the player team achieves the first place, and the player loses in the case in which a character affiliated with the competition opponent team achieves the first place.

Note that, in the case in which the event race result is a lose, a continue function can be utilized, as with the training function. The continue function can be utilized by performing a tap input to a continue button 510 provided on the competition result screen, and the competition processing is re-executed when a tap input on the continue button 510 is accepted. However, as shown in FIG. 11, in the case in which the event race result is a win, the continue function cannot be utilized and the continue button 510 is displayed in a grayed-out manner.

In addition, in the competition processing, an automatic retry function for the running simulation may be provided. For example, said function may be configured so that, in the case in which the player team includes a character that is the favorite of the event race, the result of re-executing the running simulation can be acquired by internally transmitting the competition result request to the server 20 without notifying the player even if the simulation result received from the server 20 is a lose for the player team.

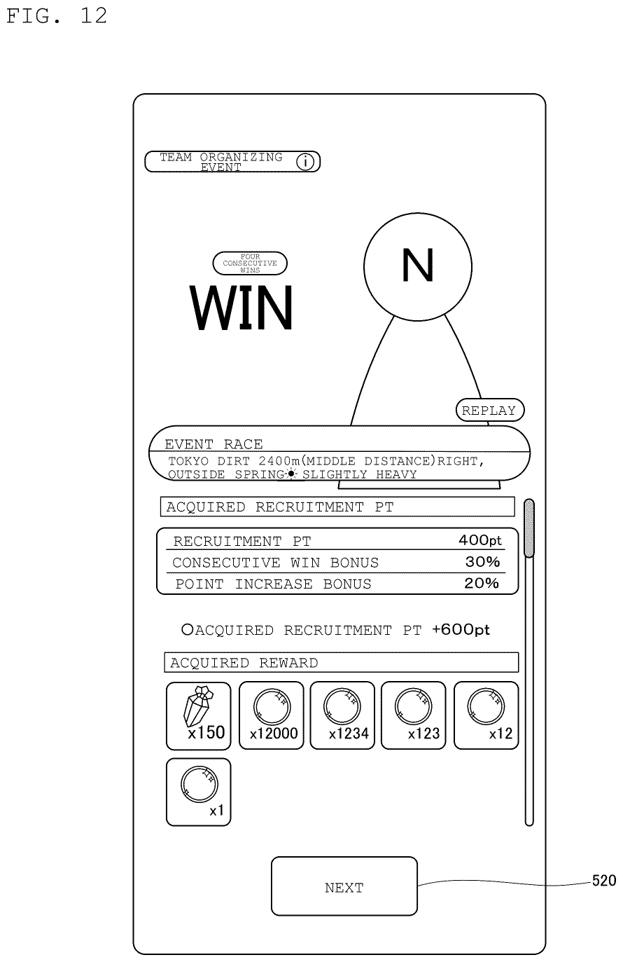

Also, when a tap input is performed on an advance button 511 on the competition result screen, the display screen transitions to a reward acquisition screen, as shown in FIG. 12. In this embodiment, rewards in accordance with the win/lose result of the event race are given. In particular, in this embodiment, rewards for entering the event race include recruitment points, the recruitment points are used when recruiting the characters, described later. The acquired amounts of the recruitment points are greater when the player wins the event race than when the player loses the event race. In addition, there is also point increase bonuses, which are bonus multipliers in accordance with the number of consecutive wins in the event race and the number of characters registered in the illustrated reference book, and the actual acquired amounts of the recruitment points are a result of adding the bonus increase amount due to the bonus multipliers to the basic acquired amount in accordance with the win/lose of the event race.

In addition, in the competition result processing, the illustrated reference book data are also updated in accordance with the competition result in the event rate. Specifically, when the player team wins the event race, if there is a character that is not registered in the illustrated reference book among the seven characters affiliated with said team, character roster information of the illustrated reference book data is updated by using said character as the registration target. Accordingly, in this embodiment, registration conditions for the illustrated reference book are that the character that is not registered in the illustrated reference book is affiliated with the player team and that said team wins the event race.

In addition, in this embodiment, the illustrated reference book data that are updated in accordance with the competition result of the event race include team skill information. The team skill information indicates the acquisition state of team skills, which are applied in the team organizing event. There are a plurality of types of team skills, and there are combinations of the characters in accordance with the types of the team skills. The acquired team skills are applied to all of the characters affiliated with the team in the running simulation of the event race and the calculation of the team evaluation points. If there is a combination of the characters corresponding to a team skill, regarding the seven characters affiliated with the player team entering the event race, when the player team wins the event race, the team skill information of the illustrated reference book data is updated by using the team skill corresponding to said combination as the acquisition target.

Accordingly, in this embodiment, there are cases in which the illustrated reference book data are updated in the case in which the player wins against the competition opponent team in the event race, and the illustrated reference book data are not updated when it is confirmed that the player loses against the competition opponent team in the event race. Note that the illustrated reference book data may be updated even in the case in which the player loses against the competition opponent team in the event race. In other words, entering the event race may be employed as a condition for updating the illustrated reference book data (updating at least one of the character roster information and the team skill information) regardless of the win/lose of the event race.

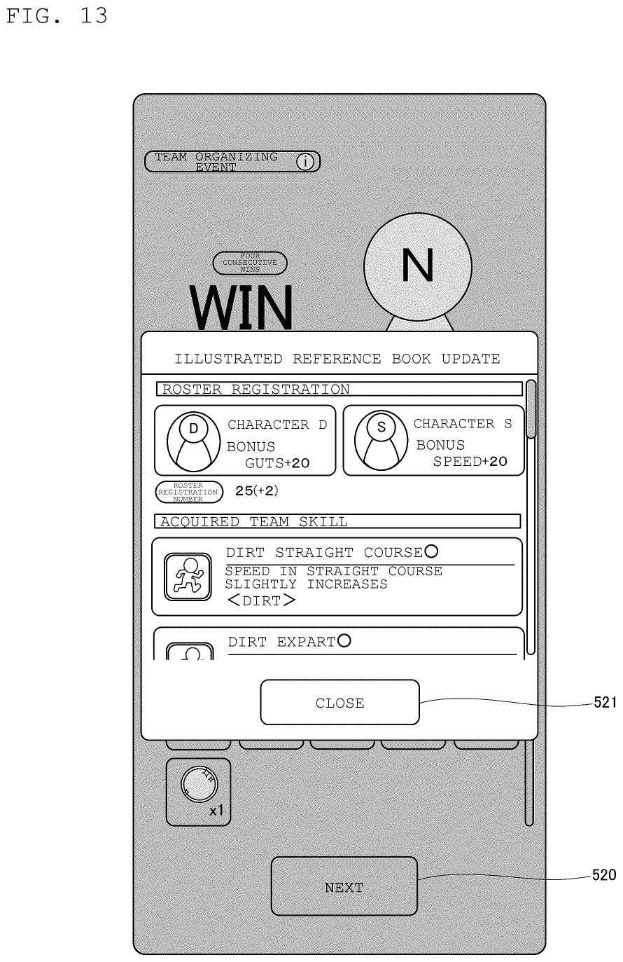

Also, in the competition result processing, in the case in which it is confirmed that the player has won against the competition opponent team and the illustrated reference book data are updated (“Y” in step S104 and “Y” in step S105), as shown in FIG. 13, an illustrated-reference-book update notification dialog that notifies about the update specifics of the illustrated reference book data is displayed as a pop-up display when the display screen transitions to the reward acquisition screen, and thus, team-evaluation updating processing is performed (step S106). Note that the illustrated-reference-book update notification dialog is provided with a close button 521, and, when a tap input is performed on the close button 521, the illustrated-reference-book update notification dialog is closed.

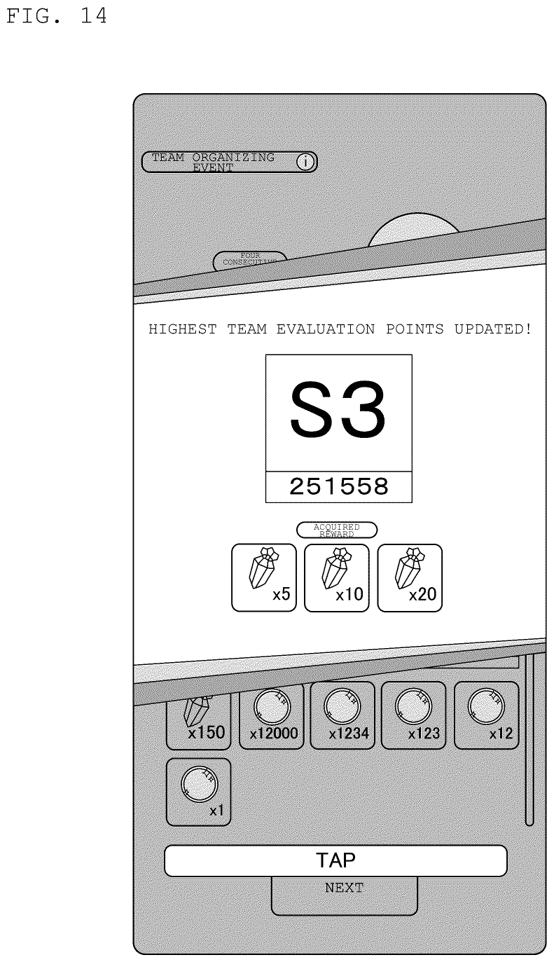

In team-evaluation updating processing based on the updating of the illustrated reference book data after the event race, the update specifics of the illustrated reference book data are reflected in the team evaluation point. Specifically, in the case in which the character roster information is updated, a performance increase bonus given in accordance with the type of newly registered character is applied to all of the seven characters affiliated with the current team to calculate the evaluations points of the respective characters, and the team evaluation points are calculated. In addition, in the case in which the team skill information is updated, the newly released team skill is applied to all of the seven characters affiliated with the current team to calculate the evaluation points of the respective characters, and the team evaluation points are calculated. In the case in which the highest team evaluation points are updated as a result of calculating the team evaluation points, a team-evaluation update dialog shown in FIG. 14 is displayed as a pop-up display so as to replace the illustrated-reference-book update notification dialog when the illustrated-reference-book update notification dialog is closed. In the case in which the team-evaluation update dialog is displayed, as a result of any portion of the display screen being tapped, the team-evaluation update dialog is closed and the reward acquisition screen is restored.

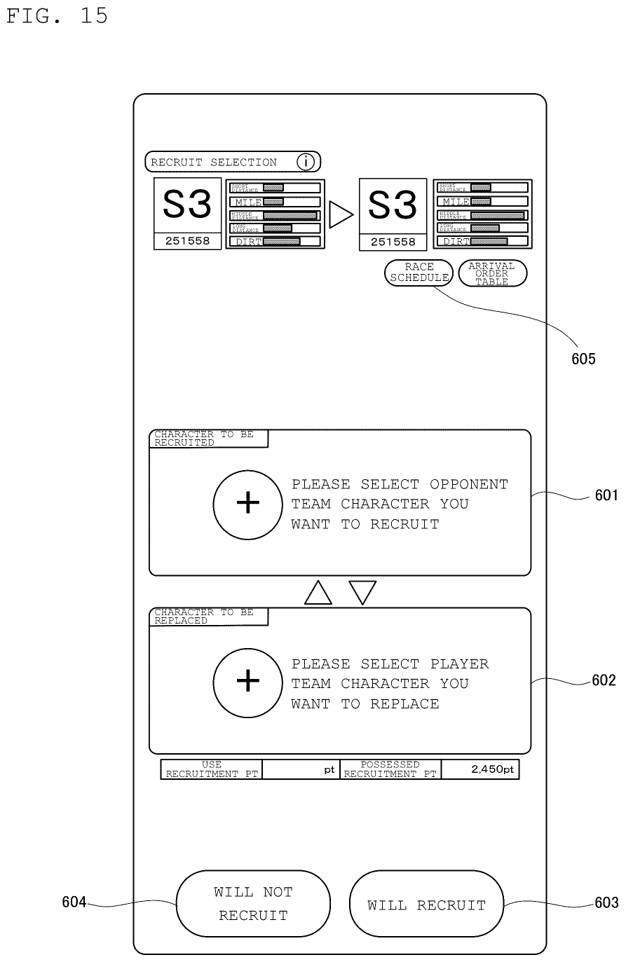

Also, when the player has won the event race and a tap input is performed on an advance button 520 on the reward acquisition screen, recruitment processing is performed (step S107). In this embodiment, because winning against the competition opponent team in the event race is employed as the execution condition of the recruitment processing, the recruitment processing is not executed in the case in which it is confirmed that the player has lost against the competition opponent team in the event race (“N” in step S104). In the recruitment processing, a recruitment accepting screen is displayed in the player terminal 40, as shown in FIG. 15, and the selection of a recruitment target character from the characters affiliated with the competition opponent team is accepted and the selection of a replacement target character from the characters affiliated with the player team is accepted.

The recruitment accepting screen is provided with a race schedule confirmation button 605, and, when a tap input is performed on the race schedule confirmation button 605, it is possible to confirm an overview of event races scheduled to be entered in the future. In this embodiment, by organizing the team by recruiting characters having high aptitudes regarding the event races scheduled to be entered in the future, it is possible to build a team that is more likely to win the event races.

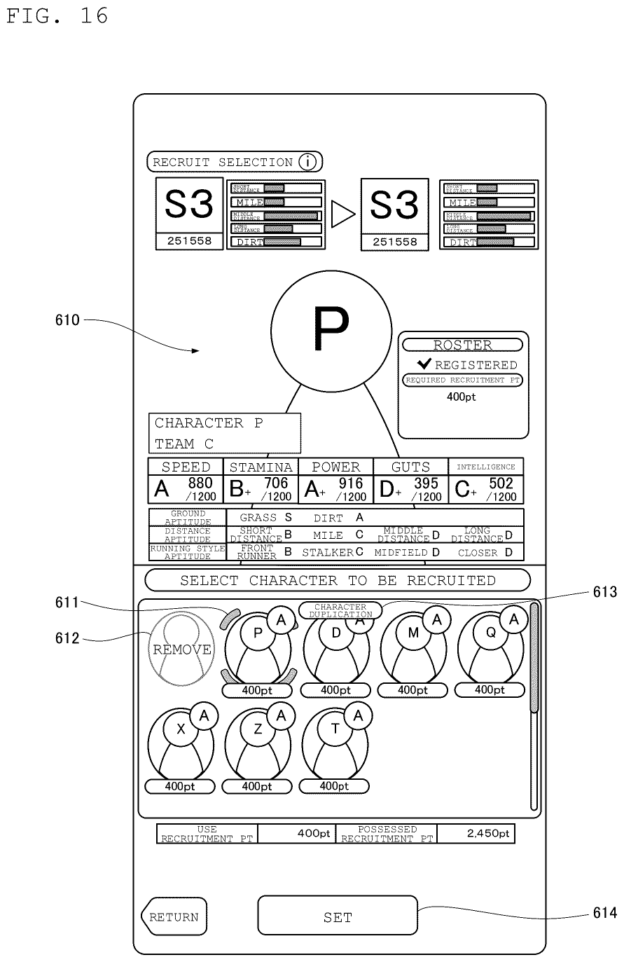

In addition, the recruitment accepting screen is provided with a recruitment target box 601 and a replacement target box 602. When a tap input is performed on the recruitment target box 601 on the recruitment accepting screen, the display screen transitions to the recruitment-target selection screen shown in FIG. 16.

On the recruitment-target selection screen, character icons of the seven characters affiliated with the competition opponent team are displayed. In the example shown in FIG. 16, the amounts of recruitment points required to recruit said characters are displayed below the respective character icons. When a tap input is performed on a character icon displayed on the recruitment-target selection screen, a selection mark 611 is attached to said character icon and detail information of the selected character is displayed in a recruitment target display area 610. It is preferable that the detail information to be displayed related to the selected character includes whether or not there is a registration regarding the character roster information, the information about the amount of the recruitment points required for the recruitment. In addition, when a tap input is performed on a selection cancel button 612 on the recruitment-target selection screen, it is possible to cancel the state in which the character is selected.

In addition, in this embodiment, any one of the seven characters affiliated with the competition opponent team can be selected as the recruitment target. However, because two or more characters of the same type cannot be affiliated with a team, on the recruitment-target selection screen, duplicate badges 613 are attached to the character icons of the characters that are of the same types as the characters affiliated with the player team, and it is notified that the characters of the same types are affiliated with the player team.

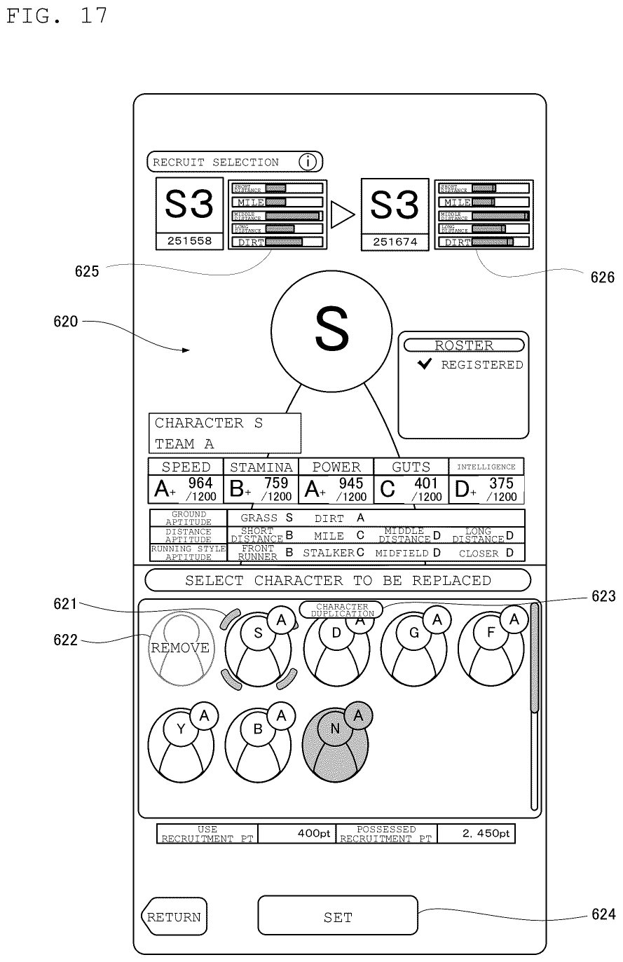

In addition, when a tap input is performed on the replacement target box 602 on the recruitment accepting screen, the display screen transitions to a replacement-target selection screen shown in FIG. 17.

On the replacement-target selection screen, character icons of the seven characters affiliated with the player team are displayed. When a tap input is performed on a character icon displayed on the replacement-target selection screen, a selection mark 621 is attached to said character icon and detail information of the selected character is displayed in a replacement-target display area 610. It is preferable that the detail information to be displayed related to the selected character includes whether or not there is a registration regarding the character roster information. In addition, when a tap input is performed on a selection cancel button 622 on the replacement-target selection screen, it is possible to cancel the state in which the character is selected. In addition, on the replacement-target selection screen, the degrees of gauge changes are visualized and displayed by means of a pre-recruit team status display 625 and a post-recruit team status display 626.

In addition, in this embodiment, of the seven characters affiliated with the player team, the captain cannot be selected as the replacement target, and any one of the six members can be selected as the replacement target. In addition, as already has been described, because two or more characters of the same type cannot be affiliated with a team, on the replacement-target selection screen, duplicate badges 623 are attached to the character icons of the characters that are of the same types as the characters affiliated with the competition opponent team, it is notified that the characters of the same types are affiliated with the competition opponent team.

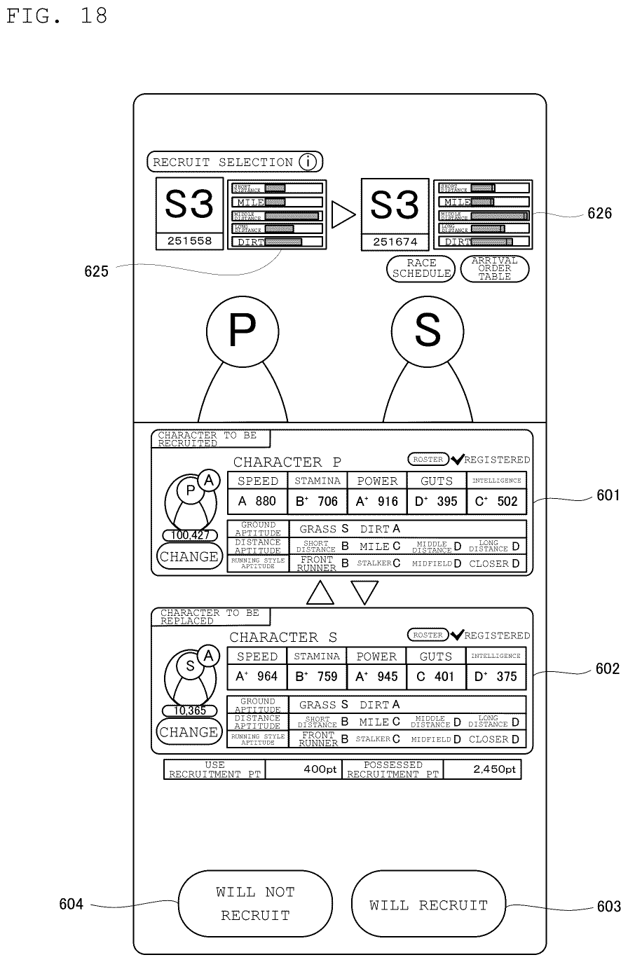

Also, as shown in FIG. 18, when a tap input is performed on a recruitment execution button 603 provided on the recruitment accepting screen in the situation in which the character serving as the recruitment target and the character serving as the replacement target are selected, the team organization information is updated such that the character serving as the replacement target is excluded from the player team and the character serving as the recruitment target is affiliated with the player team. In addition, in this embodiment, whether or not to recruit a character from the characters of the competition opponent team is optional for the player, and, in the case in which the competition opponent team does not include a character that the player hopes to recruit, it is also possible not to recruit a character by performing a tap input on a recruit non-execution button 604 provided on the recruitment accepting screen. In addition, on the recruitment accepting screen also, the degrees of gauge changes are visualized and displayed by means of the pre-recruit team status display 625 and the post-recruit team status display 626.

In the case in which a tap input is performed on a recruitment execution button 603 on the recruitment accepting screen and there is a member change in the player team (“Y” in step S108), the team-evaluation updating processing is performed (step S109). On the other hand, when a tap input is performed on a recruit non-execution button 604 on the recruitment accepting screen, there is no member change in the player team (“N” in step S108); therefore, a series of processing related to the team organizing event is ended without performing the team-evaluation updating processing.

In the team-evaluation updating processing based on the character recruitment, the evaluations points are calculated for the seven characters affiliated with the player team after the character recruitment, and the team evaluation points are calculated. In this case also, the performance increase bonus and the team skill based on the illustrated reference book data are applied to each of the seven characters affiliated with the player team to calculate the evaluation points of the respective characters. Note that, in this embodiment, regarding the character recruitment, the team evaluation points are calculated in the player terminal 40 in correspondence with changes in the recruitment target character and the replacement target character until a tap input is performed on the recruitment execution button 603 on the recruitment accepting screen, and, when a tap input is performed on the recruitment execution button 603 and the character recruitment is determined, the team evaluation points are confirmed by communicating with the server 20 and the team evaluation points associated with the player ID are updated.

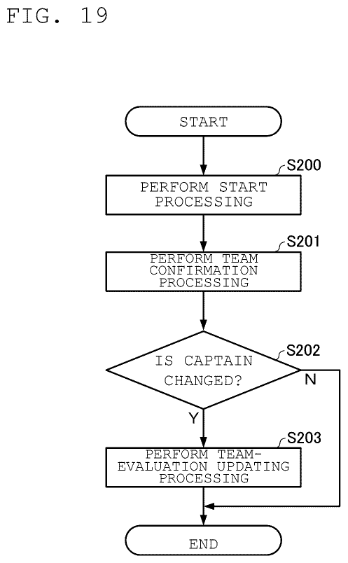

In addition, in this embodiment, the team organization information is also updated in the case in which the captain is changed. In the following, the case of changing the captain of the team will be described in accordance with the flow chart shown in FIG. 19.

The captain can be changed from an event top screen displayed in the start processing for accepting the start of the team organizing event (step S200). The event top screen shown in FIG. 5 is provided with a team confirmation button 303, and, when a tap input is performed on the team confirmation button 303, team confirmation processing is performed (step S201).

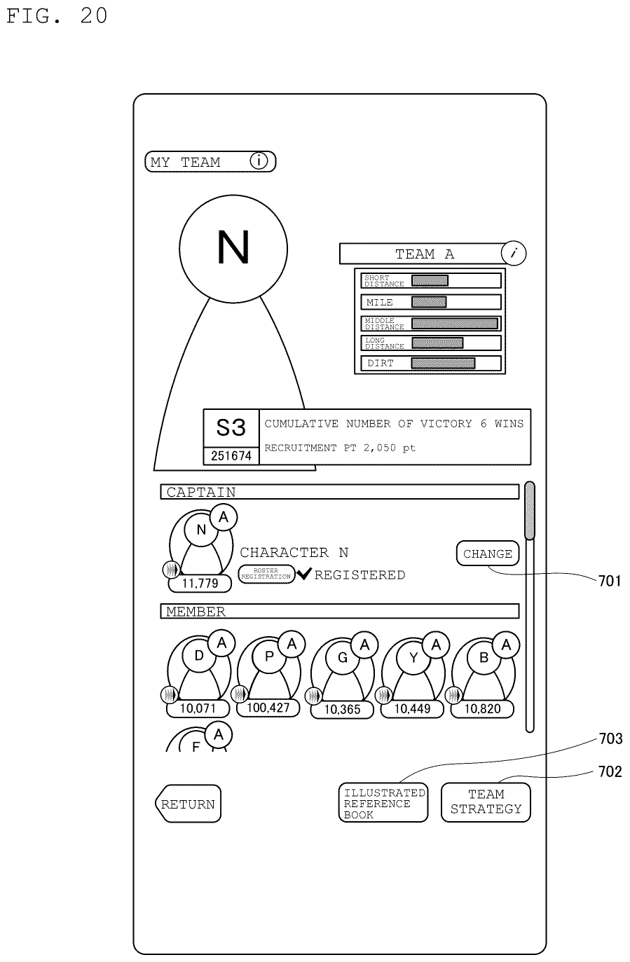

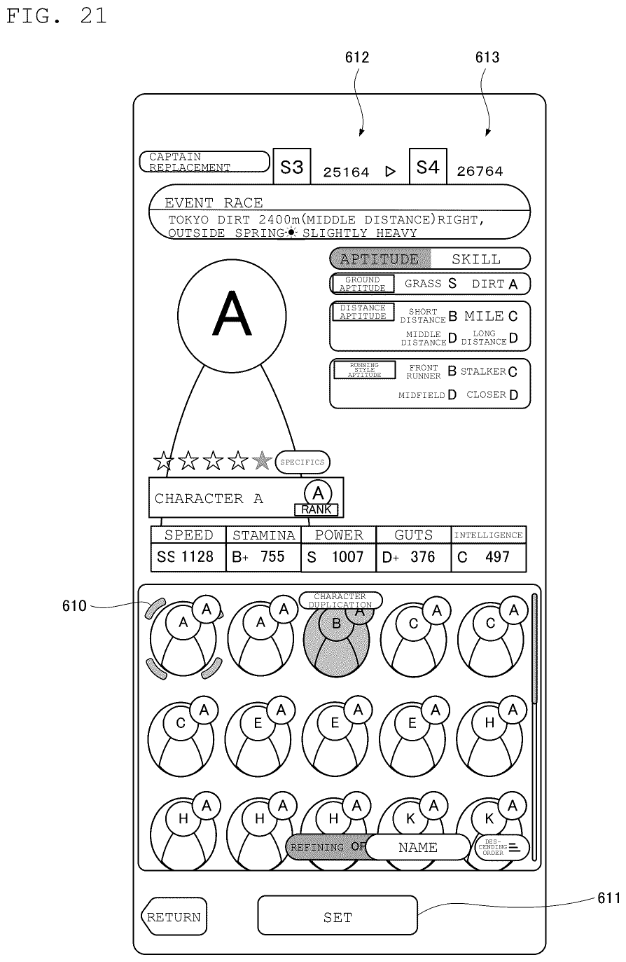

Specifically, as shown in FIG. 20, a team confirmation screen that displays the team organization information of the player is displayed. On the team confirmation screen, the captain and the members are distinguished, and the character icons of the corresponding characters are displayed. A display field for the character corresponding to the captain displays whether or not there is a registration regarding the character roster information and is provided with a captain change button 701, and, when a tap input is performed on the captain change button 701, a captain selection screen is displayed, as shown in FIG. 21. On the captain selection screen, a list of the trained characters that the player possesses are displayed in the form of the character icons, and, when a tap input is performed on a character icon, a selection mark 610 is attached to the character icon and the state in which the character corresponding to the character icon is selected is set. In addition, as has already been described, because two or more characters of the same type cannot be affiliated with a team, the character icons of characters that are of the same types as any of the six members of the team are displayed in a grayed-out manner and cannot be selected. In addition, on the captain selection screen, whether or not there is a registration regarding the character roster information may be displayed as the detail information of the selected character.

In addition, in the team confirmation processing, each time the selected character icon is changed on the captain selection screen, the calculation of the team evaluation points and the determination of the team rank are performed, and the degrees of changes in the team evaluation points and the team rank before and after changing the captain can be confirmed by means of a pre-change evaluation display area 612 and a post-change evaluation display area 613.

Also, when a tap input is performed on a decision button 611 on the captain selection screen, the character corresponding to the selected character icon is set to be the captain of the player team, and the team confirmation screen is restored on the display screen. In the case in which the captain is changed at this time (“YES” in step S202), the team-evaluation updating processing is performed and the team evaluation points are updated (step S203).

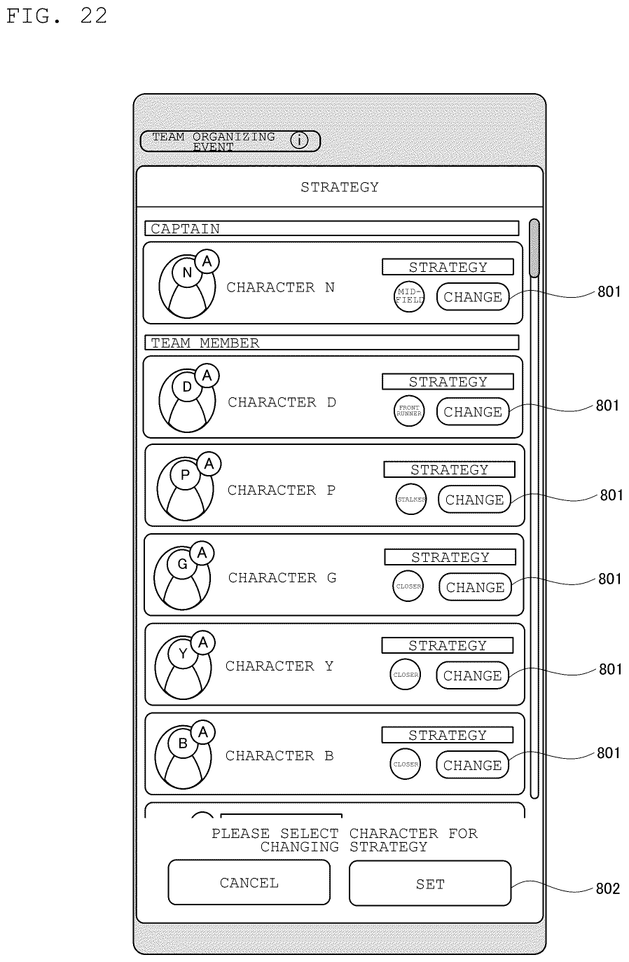

In addition, in this embodiment, when a tap input is performed on a team strategy button 702 provided on the team confirmation screen, a team strategy dialog is displayed, as shown in FIG. 22, and it is possible to change a strategy, which is one of action conditions of the characters affiliated with the player team in the event race. The strategy is an action condition related to positioning of the characters in the event race and can be set to one of four types of strategies (“front runner”, “stalker”, “midfield”, and “closer”). A running style aptitude, which indicates the level of aptitude for each of the “front runner”, the “stalker”, the “midfield”, and the “closer”, is set to each of the characters, and, by selecting a strategy with a high running style aptitude, the running simulation is executed in such a way that the advantageous positioning is more likely to be achieved in the event race. The team strategy dialog is provided with strategy change buttons 801 so as to correspond to the characters affiliated with the player team, and the strategy can be changed for a character corresponding to a strategy change button 801 on which a tap input is performed. Also, when a tap input is performed on a decision button 802 provided in the team strategy dialog, the strategy is confirmed for each of the characters displayed in the team strategy dialog and the team organization information is updated.

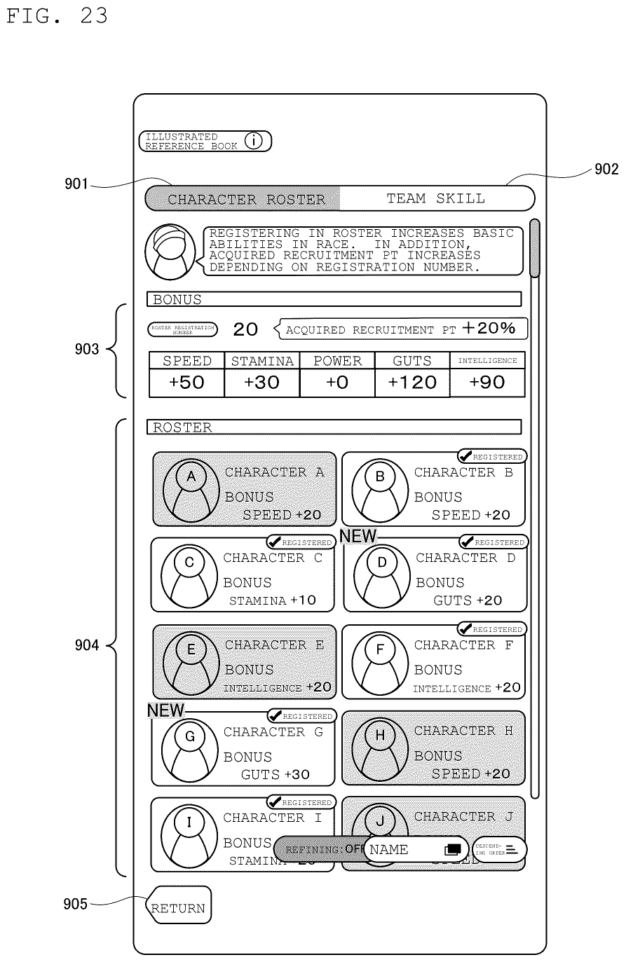

In addition, in this embodiment, the registration contents of the illustrated reference book can be viewed on an illustrated-reference-book viewing screen to which transition occurs from the event top screen or the team confirmation screen. Specifically, when a tap input is performed on an illustrated-reference-book viewing button 304 provided on the event top screen shown in FIG. 5 or when a tap input is performed on an illustrated-reference-book viewing button 703 provided on the team confirmation screen shown in FIG. 20, the display screen transitions to the illustrated-reference-book viewing screen, as shown in FIG. 23.

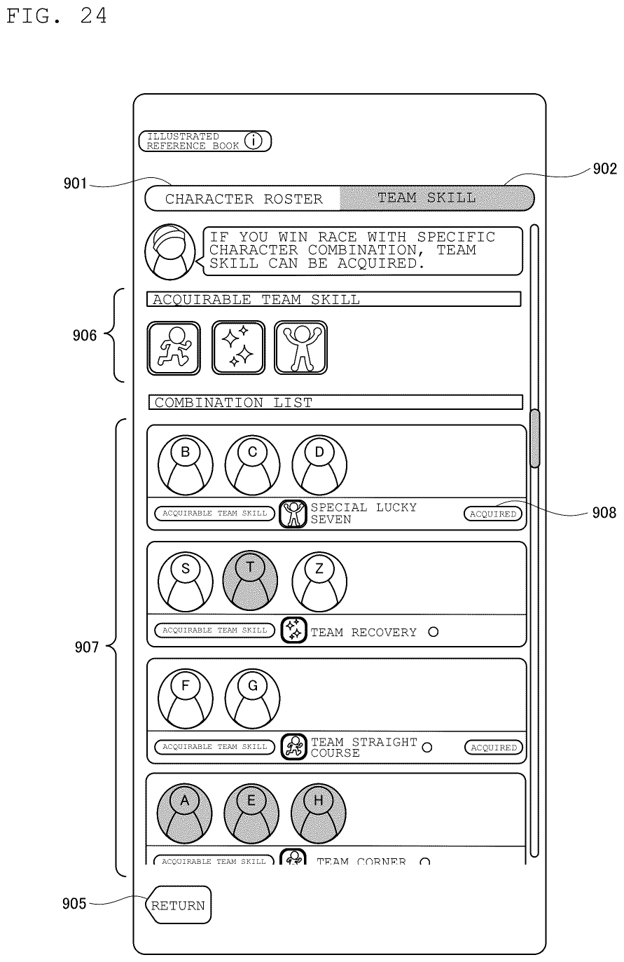

On the illustrated-reference-book viewing screen, the character roster information and the team skill information can be viewed, and the viewing subject can be switched by performing a tap input to a roster tab 901 or a skill tab 902. For example, as shown in FIG. 23, when a tap input is performed on the skill tab 902 in a situation in which the character roster information is displayed, the team skill information is displayed, as shown in FIG. 24. In addition, for example, when a tap input is performed on the roster tab 901 in a situation in which the team skill information is displayed, as shown in FIG. 24, the character roster information is displayed, as shown in FIG. 23.

In this embodiment, regardless of the character release status of the player in the illustrated-reference-book function, all of the characters implemented as training target characters can be registered. In other words, it is possible to obtain an opportunity to register an unreleased character in the illustrated reference book as a result of recruiting the unleased character from another player team in the team organizing event and by incorporating said character into his/her own team, even if the player cannot use said character as the training target.

In addition, in the case in which the character roster information is displayed, as shown in FIG. 23, the illustrated-reference-book viewing screen is provided with a bonus display field 903 and a roster display field 904, and, in the bonus display field 903, it is possible to confirm the specifics of the point increase bonus and the total performance increase bonus for each of the performance parameters.

In this embodiment, a plurality of stages are set for the point increase bonus in accordance with the number of characters registered in the illustrated reference book, a result of multiplying the basic values of the recruitment points, which is set in accordance with the result of the event race in the team organizing event, by a multiplier corresponding to the point increase bonus is employed as a bonus value, and the acquired amounts of the recruitment points are determined as the sum of the basic value and the bonus value.

In the roster display field 904, the registration statuses are displayed in accordance with the types of characters, roster images corresponding to registered characters are normally displayed, and roster images corresponding to unregistered characters are displayed in a grayed-out manner. In the example shown in FIG. 23, a character A is displayed in a grayed-out manner because said character is unregistered, and a character B is normally displayed because said character is registered. In addition, the roster image of each of the characters displays the specifics of the performance increase bonus in accordance with the type of character. In this embodiment, one type of performance parameter among the “speed”, the “stamina”, the “power”, the “guts”, and the “intelligence” is set as a bonus target in association with the character classification ID, and an increase amount of the bonus-target performance parameter is set. For example, regarding the characters A, the bonus-target performance parameter is set to be the “speed”, and the increase amount thereof is set be “+20”. Note that the bonus-target parameter set in accordance with the character type may not be one type and may be two or more types. In addition, the increase amount of the performance parameter in the performance increase bonus may be constant regardless of the character type or may vary depending on the character type.

In addition, in the case in which the team skill information is displayed, as shown in FIG. 24, the illustrated-reference-book viewing screen is provided with an acquired-team-skill display field 906 and a combination display field 907, and, in the acquired-team-skill display field 906, it is possible to confirm acquired team skills by means of skill icons. As a result of a tap input being performed on a skill icon displayed in the acquired-team-skill display field 906, a dialog for confirming detail information of the team skill is displayed. In addition, in the combination display field 907, it is possible to confirm character combinations with which team skills can be acquired and specifics of the team skills corresponding to the character combinations. In this embodiment, the character combinations with which the team skills can be acquired are displayed by means of the character icons; however, with regard to the character roster information, the character icons of the registered characters are normally displayed and the character icons of the unregistered characters are displayed in a grayed-out manner. In addition, in the combination display field 907, an acquired badge 908 is displayed for a character combination for which the team skill has been acquired, and thus, the player can ascertain the character combinations for which the team skills have not been acquired on the basis of whether or not the acquired badge 908 is displayed. In the example shown in FIG. 24, it can be ascertained that, by winning an event race by organizing a team with a combination of a character S, a character T, and a character Z, “team recovery o”, which is an unacquired team skill, can be acquired. Also, because it can be ascertained that the character T is unregistered in the illustrated reference book, if the player advances the team organization event by organizing a team so as to include the combination of the character S, the character T, and the character Z in order to obtain the team skill “team recovery o”, as a result of newly registering the character T in the illustrated reference book, it is not only possible to acquire the performance increase bonus corresponding to the character T but also to acquire a new team skill, and, as a result, it is possible to update the team evaluation points.

The character combinations with which the team skills can be acquired are managed in correspondence with combinations of the character classification IDs in association with skill IDs for distinguishing the team skills, and, in the case in which the player team wins the event race in the team organizing event, a search is performed on whether or not there is an acquirable skill ID that can be acquired on the basis of the character classification IDs regarding the seven characters affiliated with said team, and, in the case in which there is an acquirable skill ID, the team skill corresponding to said skill ID is set in the acquired state. It suffices that the character types constituting a character combination with which a team skill can be acquired be two or more types and can be arbitrarily set within the range of the number of characters affiliated with the team.

Accordingly, the illustrated-reference-book function in this embodiment is for recording the members recruited into the team and the captains set by the player in the form of use history in accordance with the character types and accumulating effects that are advantageous for the progression of the team organizing event in accordance with the registration status. Also, because this embodiment involves the element of aiming for increasing the character types registered in the illustrated reference book, it is possible to motivate the player to recruit numerous types of characters and use said characters in the event race.

In addition, in this embodiment, it is necessary to enter the characters in the event race and win the event race in order to obtain the illustrated reference book bonus. Accordingly, it is not possible to obtain the illustrated reference book bonus just by replacing the captain without entering the event race. In addition, in this embodiment, it is possible to achieve the registration of characters that the player have not released as trainable characters in the illustrated reference book by recruiting said characters into the team from the competition opponent teams. Accordingly, with the illustrated-reference-book function in this embodiment, in order to accumulate the illustrated reference book bonus obtained in accordance with the registration status of the illustrated reference book, it is possible to increase the options in the character selection in the team organization, such as adding a character to the members even if said character is weak.

In addition, in this embodiment, because the illustrated reference book bonus is applied in the event race, a player having accumulated a greater amount of the illustrated reference book bonus is more likely to win the event race, and thus, the team rank thereof is more likely to be improved by recruiting characters with greater evaluation points by competing against stronger teams, etc. In other words, with the element of accumulating the illustrated reference book bonus in accordance with the registration status of the illustrated reference book, it is possible to motivate the player to use various characters.

As has been described above, this embodiment is configured so that the presence/absence of a registration status in the illustrated reference book is managed in association with the character types and the illustrated reference book bonuses, which are advantageous in the progression of the team organization event, are set in accordance with the character types registered in the illustrated reference book, and said features act as motivations for handling the team organizing event in order to satisfy the registration conditions of the illustrated reference book for various characters, and thus, it is possible to enhance the game interest of the player.

In addition, in this embodiment, the character registration in the illustrated reference book is enabled in the team organizing event held in a period set in advance. Also, a team organizing event can be repeatedly held, such as the first time, the second time, and the third time, by changing the period in which the event is held. In this case, it is possible to set the illustrated reference book bonus corresponding to the period in which the team organizing event is held. For example, the illustrated reference book bonus can be configured so that the correspondence relationships between the character type and the performance increase bonus are different in accordance with the team organizing event to be held, the character combinations for acquiring the team skills are different in accordance with the team organizing event to be held, or new team skills that did not exist in the team organization event executed in the past can be acquired. By employing such configurations, the player can be motivated to handle a team organizing event to be newly executed for the purpose of obtaining the illustrated reference book bonus in a different form from the team organizing event experienced in the past.

In addition, in this embodiment, the characters to be organized into the team by the player can be selected from the plurality of types of characters in the team organizing event, and the illustrated reference book bonuses set in accordance with the types of characters selected as the registration targets for the illustrated reference book are applied to the competition in the event race regardless of the types of characters affiliated with the team. In other words, in this embodiment, the additional statuses acquired in the past are equally applied to the respective characters affiliated with the team organized with regard to the next and subsequent event races. If the illustrated reference book bonuses are configured such that the illustrated reference book bonuses are applied only to the same types of characters as the characters registered in the illustrated reference book, the characters incorporated in the team would be biased in order to receive the application of the illustrated reference book bonuses, and there is a risk of losing the uniqueness of the respective player teams; however, as a result of making it possible to receive the application of the illustrated reference book bonuses regardless of the characters incorporated into the team, it is possible to increase the options for the character selection in organizing the team and it is possible to guarantee the diversity of team organization.

In addition, in this embodiment, in the case in which the registration condition of the illustrated reference book is satisfied as a result of the team being organized by the player selecting the characters to be used and entered in the event race, it is possible to acquire the additional statuses for the characters, such as the performance increase bonus and the team skills, and it is possible to apply the acquired additional statuses when entering the next and subsequent event races; therefore, even an inexperienced player is likely to feel the sense of expectation that it is possible to more advantageously advance the next event race than the current event race, and, as a result, the player can be motivated to continuously play the game, and thus, it is possible to enhance the game interest of the player.

In addition, in this embodiment, in the case in which the event race is won in a situation in which the team organized by the player includes a character combination corresponding to a team skill, the team skill corresponding to the character combination incorporated into the team regarding the current event race is acquired; therefore, as a result of including the element of taking the character combinations into consideration in organizing the team, in addition to aiming for registering each of the characters in the illustrated reference book, it is possible to increase the options for the character selection in organizing the team and it is possible to guarantee the diversity of team organization.

In addition, various effects can be employed as the effects that are advantageous for the game progression and that are obtained due to the illustrated reference book bonuses, such as increasing the acquired amounts of items, increasing the acquired amounts of experience values, and imparting status reduction effects (debuff effects) to the characters of the competition opponent in a competition.

In addition, with the team organizing event provided by means of the event function of this embodiment, the number of times the trained characters that the player possesses are recruited may be counted and rewards in accordance with the number count may be given to the player. In addition, the team organization event may include a function for displaying the player team evaluation points and the team rank in a ranking style.

In addition, as an element for providing an active motivation for replacing the members by means of the recruitment when organizing a team, the abilities of the replacement target character may be carried over to the recruitment target character when performing the recruitment. The aptitudes, the performance parameters, the skills, etc. can be set to be the carry-over target abilities and the carry-over target abilities may be determined by means of a lottery or the player may be allowed to select the carry-over target abilities. In the case in which the skills are set to be the carry-over target abilities, an upper limit on the number of the skills that can be carried over may be provided for each of the players or the character types. In addition, it may be possible to replace the carried-over skills or it may be prohibited to remove the skills that have once been carried over. In addition, in the case in which the aptitudes are set to be the carry-over target abilities, the aptitudes of the recruitment target character may be configured to increase in the case in which the replacement target character satisfies a prescribed condition in terms of the aptitudes. Note that in the case in which it is possible to carry over the abilities of the replacement target character to the recruitment target character, it is also possible to apply the carried-over abilities to the calculation of the team evaluation points and the event-race running simulation.

In addition, the performance increase bonuses may be configured so as to be determined with reference to the rarity of the characters registered in the illustrated reference book. For example, in the case in which the registration conditions of characters are satisfied in a situation in which the rarity of said characters is higher than that of the characters that are already registered, even if the character types are the same therebetween, the character roster information in the illustrated reference book data may be updated so as to change the performance increase bonuses. In this case, the performance increase bonuses may be configured so that the increase amounts of the performance parameters in the performance increase bonuses change in accordance with the rarity of the characters for which the registration conditions are satisfied or the types of performance parameters set to be the bonus subjects and the increase amounts thereof are increased in accordance with the rarity of the characters for which the registration conditions are satisfied.

In addition, the management of the character roster information has been described in this embodiment in terms of the case in which the characters are registered without distinguishing the captain and the members; however, the case of registering a character incorporated into the team as the captain may be distinguished from the case of registering characters incorporated into the team as the members. In the case in which the captain registration is distinguished from the member registration, there may be a difference in the performance increase bonuses. For example, the increase amounts in the performance parameters in the performance increase bonuses may be greater in the case of the captain registration than the case of the member registration.

In addition, the team-skill acquisition conditions may be set so that the characters do not overlap among the character combinations with regard to the character combinations with which the team skills can be acquired or may be set so that some of the characters overlap among the combinations. For example, there may be a case in which a combination of the character A and the character B is set as the character combination corresponding to a team skill A and a combination of the character B and the character C is set as the character combination corresponding to a team skill B.

In addition, there may be an acquisition form in which there is a second character combination that encompasses a first character combination and the team skill that can be acquired with the second combination is a higher version of the team skill that can be acquired with the first combination. For example, it is possible to acquire the team skill A with the first combination with the character A and the character B and it is possible to acquire the team skill B, which is a higher version of the team skill A, with the second combination with the character A, the character B, and the character C. Between the team skill A and the team skill B, the team skill B is more advantageous than the team skill A in terms of at least one of the effect magnitude and the effect duration of the skill. In this case, a simultaneous application of the acquired team skill A and team skill B may be allowed or the simultaneous application of the team skill A and the team skill B may not be allowed. In the case in which the simultaneous application of the team skill A and the team skill B is allowed, the team skill A and the team skill B can both be applied to the event-race running simulation and the calculation of the team evaluation points after the acquired state is achieved for both the team skill A and the team skill B. On the other hand, in the case in which the simultaneous application of the team skill A and the team skill B is not allowed, it is possible to set the team skill B to the acquired state instead of the team skill A in the case in which the acquisition condition for the team skill B is satisfied in a situation in which the team skill A has been acquired. In addition, after the acquired state is achieved for both the team skill A and the team skill B, processing for applying the team skill B to the event-race running simulation and the calculation of the team evaluation points without applying the team skill A thereto may be performed.

In addition, the configuration for providing the respective functions of the information processing system 10 of this embodiment can be applied to sport games, for example, baseball games, soccer games, etc., in which characters that participate in competitions are trained, events are advanced by utilizing characters trained by the player himself/herself and characters trained by other players, and the characters are registered in an illustrated reference book. In addition, said configuration may be applied to games of other genres, for example, card battle games, fighting games, action games, battle royale games, role playing games, etc., in which characters are trained, events are advanced by utilizing characters trained by the player himself/herself and characters trained by other players, and the characters are registered in an illustrated reference book.

1. A program for a game in which a plurality of types of characters appear,
the program causing a computer to function as an illustrated-reference-book-function provision portion that registers the characters that have satisfied a registration condition in an illustrated reference book, wherein
the illustrated-reference-book-function provision portion
manages the presence/absence of a registration status in the illustrated reference book in association with the types of characters and sets advantageous effects for the progression of the game in accordance with the types of characters registered in the illustrated reference book.

2. A program according to claim 1, wherein
the illustrated-reference-book-function provision portion
enables the registration of the characters in the illustrated reference book in an event held for a period set in advance and the advantageous effects are set in correspondence with the period in which said event is held.

3. A program according to claim 1, wherein:
the characters to be used by a player can be selected from the plurality of types of characters; and
the advantageous effects set in accordance with the types of characters selected as the registration targets for the illustrated reference book are applied to the game progression regardless of the types of characters selected as the use targets.

4. A program according to claim 1, wherein:
a team can be organized by the player selecting the characters from the plurality of types of characters; and
the illustrated-reference-book-function provision portion
registers the characters in the illustrated reference book on the basis of organization information of the team.

5. An information processing system for a game in which a plurality of types of characters appear,
the system comprising an illustrated-reference-book-function provision portion that registers the characters that have satisfied a registration condition in an illustrated reference book, wherein
the illustrated-reference-book-function provision portion
manages the presence/absence of a registration status in the illustrated reference book in association with the types of characters and sets advantageous effects for the progression of the game in accordance with the types of characters registered in the illustrated reference book.

6. An information processing method for a game in which a plurality of types of characters appear, the method comprising:
an illustrated-reference-book registering step of registering the characters that have satisfied a registration condition in an illustrated reference book and managing the presence/absence of a registration status in the illustrated reference book in association with the types of characters; and
an effect setting step of setting advantageous effects for the progression of the game in accordance with the types of characters registered in the illustrated reference book.
